(19) United States
(12) Patent Application Publication
(10) Pub. No.: US 2017/0118125 A1
(43) Pub. Date: Apr. 27, 2017

(54) RADIO FREQUENCY FRONT END DEVICES WITH HIGH DATA RATE MODE

(71) Applicant: QUALCOMM Incorporated, San Diego, CA (US)

(72) Inventors: Lalan Jee Mishra, San Diego, CA (US); Richard Wietfeldt, San Diego, CA (US); Helena Deirdre O'Shea, San Diego, CA (US); Zhenqi Chen, Shirley, MA (US); Wolfgang Roethig, San Jose, CA (US)

(21) Appl. No.: 15/298,015

(22) Filed: Oct. 19, 2016

Related U.S. Application Data
(60) Provisional application No. 62/245,715, filed on Oct. 23, 2015.
(60) Provisional application No. 62/348,635, filed on Jun. 10, 2016.

(51) Int. Cl. H04L 12/801; H04L 29/06; H04L 12/741

(52) U.S. Cl. CPC H04L 47/193; H04L 45/74; H04L 69/164

(57) ABSTRACT

Methods and apparatuses are described that facilitate the communication of data between a transmitter and a receiver across a serial bus interface. In one configuration, a transmitter generates a datagram based on a register address, detects whether the register address is within a high data rate (HDR) access address range, and sends a payload of the datagram to the receiver according to a HDR mode when the register address is within the HDR access address range. In another configuration, the transmitter generates a datagram including at least a command field and a data field, sends the command field to the receiver according to a single data rate (SDR) mode, wherein the command field indicates a transition to a high data rate (HDR) mode for sending the data field, and sends the data field to the receiver according to the HDR mode.

### CROSS-REFERENCE TO RELATED APPLICATIONS

This application claims priority to and the benefit of U.S. Provisional Application Ser. No. 62/245,715, entitled “RADIO FREQUENCY FRONT END DEVICES WITH HIGH DATA RATE MODE” filed on Oct. 23, 2015 and U.S. Provisional Application Ser. No. 62/348,635, entitled “RADIO FREQUENCY FRONT END DEVICES WITH HIGH DATA RATE MODE” filed on Jun. 10, 2016, the entire contents of which are incorporated herein by reference.

### BACKGROUND

Field

The present disclosure relates generally to data transfer, and more particularly, to radio frequency front end (RFFE) devices having a high data rate mode.

Background

As the mobile device market mushroomed with the development of multifunctional smartphones, cellular communication complexity has increased accordingly. It is now conventional for a radio front end of a mobile device to cover as many as ten or more frequency bands. The radio front end thus requires multiple power amplifiers, diplexers, low-noise amplifiers, antenna switches, filters, and other radio frequency (RF) front end devices to accommodate the radio signaling complexity. These various RF front end devices are in turn controlled by a host or master device such as a radio frequency integrated circuit (RFIC). As the RF front end complexity increased, the need for a standardized protocol to control the many different devices lead to the development of the Mobile Industry Processor Interface (MIPI) RF Front-End Control Interface (RFFE) standard.

The RFFE standard specifies a serial bus that includes a clock line and a bidirectional data line. Through the RFFE bus, an RFFE master device may read from, and write to, registers in a plurality of RFFE slave devices so as to control the RF front-end devices. The read and write commands are organized in the RFFE standard into protocol messages that may each include an initial sequence start condition (SSC), a command frame, a data payload, and a final bus park cycle. The protocol messages include register commands, extended register commands, and extended register long commands. The protocol messages may further include broadcast commands. The register, extended register, and extended register long commands (three types of commands) can all be either read or write commands. With regard to the three types of commands, the registers in each of the RFFE slave devices are organized into a 16-bit wide address space (0x0000-0xFFFF in hexadecimal). Each of the three types of commands includes a command frame that addresses a specific RFFE slave device as well as the register address. A command frame in the register command (register command frame) is directed to the registers in the first five bits of an address space (0x00-0x1F) such that only five register address bits are needed. The register command frame is followed by an 8-bit data payload frame. In contrast, an extended register command frame includes eight register address bits and may be followed by up to 16 bytes of data. Finally, an extended register long command frame includes a full 16-bit register address so it can uniquely identify any register in the addressed RFFE slave device. The extended register long command frame may be followed by up to eight bytes of data.

Each of the commands begins with a unique sequence start condition (SSC) that is then followed by a corresponding command frame, some number of data frames, and finally a bus park cycle (BPC) to signal the end of the command. The latency involved with transmitting any of the commands thus depends on the number of bits in its various frames as well as the clocking speed for the RFFE clock line. Under the RFFE protocol, each bit of a transmitted frame corresponds to a period of the clock since the transmission is single data rate (SDR), which corresponds to one bit per clock cycle. For example, an SDR results from transmitting a bit responsive to each rising edge (or to just the falling edges) of the clock. The maximum clocking speed is 52 MHz in the RFFE v2 specification. This clocking rate has increased relative to previous versions of the RFFE protocol and is associated with increased power consumption. However, even at this increased clocking rate, the latency or “flight time” with regard to transmitting the longer commands such as the extended register commands may be considerable and may not meet the increasingly complex radio frequency front end circuit system requirements. For example, an extended register read or write command may be 148 bits long (not including the SSC and BSC portions). Such a frame then requires at least 147 cycles of the RFFE clock for its transmission. The resulting latency may be unacceptable in certain Radio Access Technologies (RATs) and/or use cases associated with one or more RATs.

Accordingly, there is a need in the art for RFFE messaging with decreased latency of message flight time between the RFFE master device and its slave devices.

### SUMMARY

Embodiments disclosed herein provide systems, methods and apparatuses that facilitate the communication of data between a transmitter and a receiver across a serial bus interface.

In an aspect of the disclosure, a method performed at a transmitter for sending data to a receiver across a serial bus interface, includes communicating with the receiver to define a lower address limit and an upper address limit of a high data rate (HDR) access address range within a register space, generating a datagram based on a register address, sending the register address to the receiver according to a single data rate (SDR) mode, detecting whether the register address is within the HDR access address range, sending a payload of the datagram to the receiver according to a HDR mode when the register address is within the HDR access address range, and sending the payload of the datagram to the receiver according to the SDR mode when the register address is not within the HDR access address range.

The lower address limit includes a most significant byte (MSB) and a least significant byte (LSB). The MSB is stored in a first lower address register of the register space and the LSB is stored in a second lower address register of the register space.

The upper address limit includes a most significant byte (MSB) and a least significant byte (LSB). The MSB is stored in a first upper address register of the register space and the LSB is stored in a second upper address register of the register space.

In another aspect of the disclosure, a transmitter for sending data to a receiver, includes a serial bus interface and a processing circuit. The processing circuit is configured to communicate with the receiver to define a lower address limit and an upper address limit of a high data rate (HDR) access address range within a register space, generate a datagram based on a register address, send the register address to the receiver according to a single data rate (SDR) mode, detect whether the register address is within the HDR access address range, send a payload of the datagram to the receiver according to a HDR mode when the register address is within the HDR access address range, and send the payload of the datagram to the receiver according to the SDR mode when the register address is not within the HDR access address range.

In a further aspect of the disclosure, a transmitter for sending data to a receiver, includes means for communicating with the receiver to define a lower address limit and an upper address limit of a high data rate (HDR) access address range within a register space, means for generating a datagram based on a register address, means for sending the register address to the receiver according to a single data rate (SDR) mode, means for detecting whether the register address is within the HDR access address range, means for sending a payload of the datagram to the receiver according to a HDR mode when the register address is within the HDR access address range, and means for sending the payload of the datagram to the receiver according to the SDR mode when the register address is not within the HDR access address range.

In an aspect of the disclosure, a method performed at a receiver for receiving data from a transmitter across a serial bus interface, includes communicating with the transmitter to define a lower address limit and an upper address limit of a high data rate (HDR) access address range within a register space, receiving, from the transmitter, a register address associated with a datagram, detecting whether the register address is within the HDR access address range, receiving a payload of the datagram from the transmitter, and decoding the payload of the datagram according to a HDR mode when the register address is within the HDR access address range. The register address is received according to a single data rate (SDR) mode.

The lower address limit includes a most significant byte (MSB) and a least significant byte (LSB). The MSB is stored in a first lower address register of the register space and the LSB is stored in a second lower address register of the register space.

The upper address limit includes a most significant byte (MSB) and a least significant byte (LSB). The MSB is stored in a first upper address register of the register space and the LSB is stored in a second upper address register of the register space.

In another aspect of the disclosure, a receiver for receiving data from a transmitter, includes a serial bus interface and a processing circuit. The processing circuit is configured to communicate with the transmitter to define a lower address limit and an upper address limit of a high data rate (HDR) access address range within a register space, receive, from the transmitter, a register address associated with a datagram, detect whether the register address is within the HDR access address range, receive a payload of the datagram from the transmitter, and decode the payload of the datagram according to a HDR mode when the register address is within the HDR access address range.

In another aspect of the disclosure, a receiver for receiving data from a transmitter, includes means for communicating with the transmitter to define a lower address limit and an upper address limit of a high data rate (HDR) access address range within a register space, means for receiving, from the transmitter, a register address associated with a datagram, means for detecting whether the register address is within the HDR access address range, means for receiving a payload of the datagram from the transmitter, and means for decoding the payload of the datagram according to a HDR mode when the register address is within the HDR access address range.

In an aspect of the disclosure, a method performed at a transmitter for sending data to a receiver across a serial bus interface, includes generating a datagram, the datagram including at least a command field and a data field, sending the command field to the receiver according to a single data rate (SDR) mode, wherein the command field indicates a transition to a high data rate (HDR) mode for sending the data field, and sending the data field to the receiver according to the HDR mode.

In one configuration, the command field indicates whether the datagram is related to a read operation or a write operation, and indicates whether the datagram is an extended register command, an extended register long command, or a register command. In another configuration, the datagram includes a read/write indication bit indicating whether the datagram is related to a read operation or a write operation, and the command field indicates whether the datagram is an extended register command, an extended register long command, or a register command. In a further configuration, the datagram includes a read/write indication bit indicating whether the datagram is related to a read operation or a write operation, and includes a mode field indicating whether the datagram is an extended register command, an extended register long command, or a register command.

In another aspect of the disclosure, a transmitter for sending data to a receiver, includes a serial bus interface and a processing circuit. The processing circuit is configured to generate a datagram, the datagram including at least a command field and a data field, send the command field to the receiver via the serial bus interface according to a single data rate (SDR) mode, wherein the command field indicates a transition to a high data rate (HDR) mode for sending the data field, and send the data field to the receiver via the serial bus interface according to the HDR mode.

In a further aspect of the disclosure, a transmitter for sending data to a receiver, includes means for generating a datagram, the datagram including at least a command field and a data field, means for sending the command field to the receiver according to a single data rate (SDR) mode, wherein the command field indicates a transition to a high data rate (HDR) mode for sending the data field, and means for sending the data field to the receiver according to the HDR mode.

In an aspect of the disclosure, a method performed at a receiver for receiving data from a transmitter across a serial bus interface, includes receiving a datagram from the transmitter, the datagram including at least a command field and a data field, decoding the command field according to a single data rate (SDR) mode, wherein the command field indicates a transition to a high data rate (HDR) mode for sending the data field, and decoding the data field according to the HDR mode based on the command field indication.

In one configuration, the command field indicates whether the datagram is related to a read operation or a write operation, and indicates whether the datagram is an extended register command, an extended register long command, or a register command. In another configuration, the datagram includes a read/write indication bit indicating whether the datagram is related to a read operation or a write operation, and the command field indicates whether the datagram is an extended register command, an extended register long command, or a register command. In a further configuration, the datagram includes a read/write indication bit indicating whether the datagram is related to a read operation or a write operation, and includes a mode field indicating whether the datagram is an extended register command, an extended register long command, or a register command.

In another aspect of the disclosure, a receiver for receiving data from a transmitter, includes a serial bus interface and a processing circuit. The processing circuit is configured to receive a datagram from the transmitter via the serial bus interface, the datagram including at least a command field and a data field, decode the command field according to a single data rate (SDR) mode, wherein the command field indicates a transition to a high data rate (HDR) mode for sending the data field, and decode the data field according to the HDR mode based on the command field indication.

In a further aspect of the disclosure, a receiver for receiving data from a transmitter, includes means for receiving a datagram from the transmitter, the datagram including at least a command field and a data field, means for decoding the command field according to a single data rate (SDR) mode, wherein the command field indicates a transition to a high data rate (HDR) mode for sending the data field, and means for decoding the data field according to the HDR mode based on the command field indication.

In an aspect of the disclosure, a special case of the HDR mode is a double data rate (DDR) mode. Accordingly, aspects described below with respect to the DDR mode may also apply to the HDR mode in general.

In an aspect of the disclosure, a method performed at a transmitter for sending data to a receiver across a serial bus interface, includes enabling a double data rate (DDR) mode by setting a single bit within a configuration register at the receiver to a first value, disabling the DDR mode by setting the single bit within the configuration register at the receiver to a second value, generating a datagram to be transmitted to the receiver via the serial bus interface, sending a first portion of the datagram according to a single data rate (SDR) mode, sending a second portion of the datagram according to the DDR mode when the DDR mode is enabled, and sending the second portion of the datagram according to the SDR mode when the DDR mode is disabled. The first portion of the datagram includes a receiver address field and a command field. The second portion of the datagram includes a register address and a payload.

In another aspect of the disclosure, a transmitter for sending data to a receiver, includes a serial bus interface and a processing circuit. The processing circuit is configured to enable a double data rate (DDR) mode by setting a single bit within a configuration register at the receiver to a first value, disable the DDR mode by setting the single bit within the configuration register at the receiver to a second value, generate a datagram to be transmitted to the receiver via the serial bus interface, send a first portion of the datagram according to a single data rate (SDR) mode, send a second portion of the datagram according to the DDR mode when the DDR mode is enabled, and sending the second portion of the datagram according to the SDR mode when the DDR mode is disabled. The first portion of the datagram includes a receiver address field and a command field. The second portion of the datagram includes a register address and a payload.

In an aspect of the disclosure, a method performed at a receiver for receiving data from a transmitter across a serial bus interface, includes receiving a first datagram from the transmitter for setting a single bit within a configuration register at the receiver, detecting that a double data rate (DDR) mode is enabled when the single bit within the configuration register is set to a first value, detecting that the DDR mode is disabled when the single bit within the configuration register is set to a second value, receiving a second datagram from the transmitter, decoding a first portion of the second datagram according to a single data rate (SDR) mode, decoding a second portion of the second datagram according to the DDR mode when the DDR mode is enabled, and decoding the second portion of the second datagram according to the SDR mode when the DDR mode is disabled. The first portion of the second datagram includes a receiver address field and a command field. The second portion of the second datagram includes a register address and a payload.

In another aspect of the disclosure, a receiver for receiving data from a transmitter, includes a serial bus interface and a processing circuit. The processing circuit is configured to receive a first datagram from the transmitter for setting a single bit within a configuration register at the receiver, detect that a double data rate (DDR) mode is enabled when the single bit within the configuration register is set to a first value, detect that the DDR mode is disabled when the single bit within the configuration register is set to a second value, receive a second datagram from the transmitter, decode a first portion of the second datagram according to a single data rate (SDR) mode, decode a second portion of the second datagram according to the DDR mode when the DDR mode is enabled, and decode the second portion of the second datagram according to the SDR mode when the DDR mode is disabled. The first portion of the second datagram includes a receiver address field and a command field. The second portion of the second datagram includes a register address and a payload.

### BRIEF DESCRIPTION OF THE DRAWINGS

FIG. 1 illustrates an apparatus that includes a RF front-end (RFFE) that may be adapted according to certain aspects disclosed herein.

FIG. 2 is a block diagram illustrating a device that employs a RFFE bus to couple various front-end devices.

FIG. 3 illustrates an example of a system architecture for an apparatus employing a data link between IC devices according to certain aspects disclosed herein.

FIG. 4 is a diagram illustrating reserved command fields in an RFFE protocol.

FIG. 5 is a diagram illustrating six reserved commands used to signal an HDR mode of operation.

FIG. 6 is a diagram illustrating a modification of the reserved commands used to signal an HDR mode of operation of FIG. 5.

FIG. 7 is a diagram illustrating a modification of the reserved commands used to signal an HDR mode of operation of FIG. 6.

FIG. 8 is a diagram illustrating high data rate (HDR) enablement.

FIG. 9 illustrates diagrams of RFFE mixed-mode write datagrams.

FIG. 10 is a diagram of an RFFE register space.

FIG. 11 is a diagram of an RFFE register space having a configuration register and a page-address register.

FIG. 12 illustrates a table defining configuration register bits and a diagram depicting a function of the configuration register bits.

FIG. 13 is a diagram illustrating a relationship between clock and data with respect to single data rate (SDR) and double data rate (DDR) modes of data transmission.

FIG. 14 illustrates a double data rate (DDR) mode RFFE write timing diagram.

FIG. 15 is a diagram illustrating use of a parity bit occupying a full clock cycle in the DDR section of a datagram.

FIG. 16 is a diagram illustrating a bus park cycle (BPC) at the end of a DDR section of a datagram.

FIG. 17 is a block diagram illustrating an example of an apparatus employing a processing circuit that may be adapted according to certain aspects disclosed herein.

FIG. 18 is a flow chart of a method for sending data to a receiver in accordance with certain aspects disclosed herein.

FIG. 19 is a flow chart of another method for sending data to a receiver in accordance with certain aspects disclosed herein.

FIG. 20 is a flow chart of a further method for sending data to a receiver in accordance with certain aspects disclosed herein.

FIG. 21 is a diagram illustrating an example of a hardware implementation for a transmitting apparatus and employing a processing circuit adapted according to certain aspects disclosed herein.

FIG. 22 is a flow chart of a method for receiving data from a transmitter in accordance with certain aspects disclosed herein.

FIG. 23 is a flow chart of another method for receiving data from a transmitter in accordance with certain aspects disclosed herein.

FIG. 24 is a flow chart of a further method for receiving data from a transmitter in accordance with certain aspects disclosed herein.

FIG. 25 is a diagram illustrating an example of a hardware implementation for a receiving apparatus and employing a processing circuit adapted according to certain aspects disclosed herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computing device and/or distributed between two or more computing devices. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Exemplary Apparatus with Multiple IC Device Subcomponents

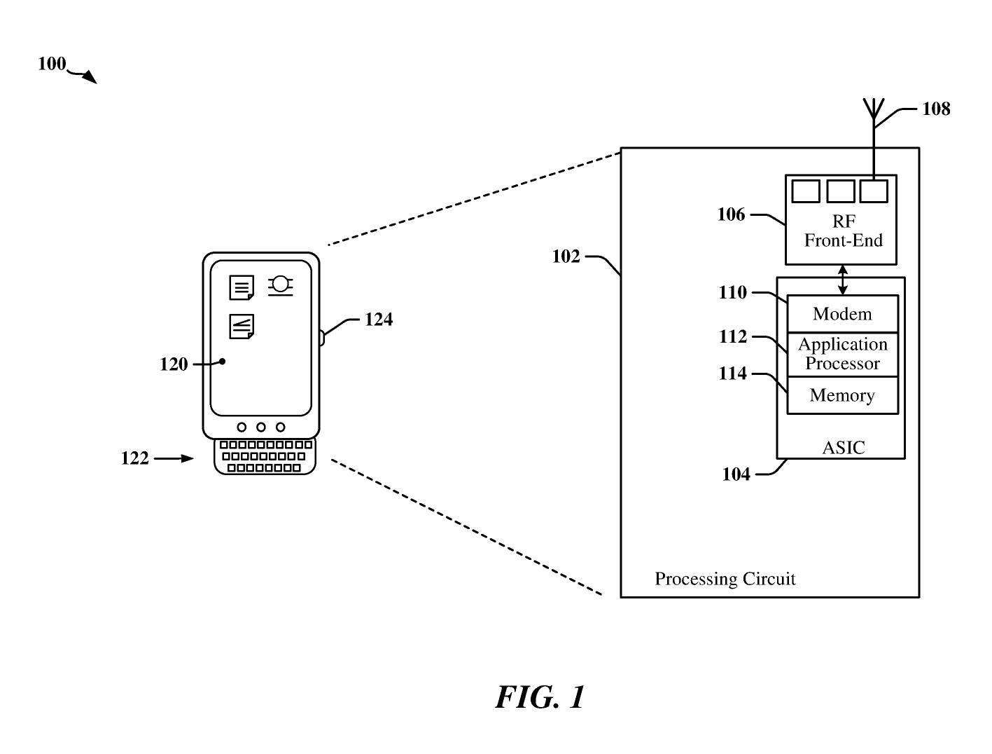

Certain aspects of the invention may be applicable to communications links deployed between electronic devices that include subcomponents of an apparatus such as a telephone, a mobile computing device, an appliance, automobile electronics, avionics systems, etc. FIG. 1 depicts an apparatus 100 that may employ a communication link between IC devices. In one example, the apparatus 100 may be a mobile communication device. The apparatus 100 may include a processing circuit having two or more IC devices 104, 106 that may be coupled using a first communication link. One IC device may be an RF front-end device 106 that enables the apparatus to communicate through one or more antennas 108 with a radio access network, a core access network, the Internet and/or another network. The RF front-end device 106 may include a plurality of devices coupled by a second communication link, which may include an RFFE bus.

The processing circuit 102 may include one or more application-specific IC (ASIC) devices 104. In one example, an ASIC device 104 may include and/or be coupled to one or more processing devices 112, logic circuits, one or more modems 110, and processor readable storage such as a memory device 114 that may maintain instructions and data that may be executed by a processor on the processing circuit 102. The processing circuit 102 may be controlled by one or more of an operating system and an application programming interface (API) layer that supports and enables execution of software modules residing in storage media. The memory device 114 may include read-only memory (ROM) or random-access memory (RAM), electrically erasable programmable ROM (EEPROM), flash cards, or any memory device that can be used in processing systems and computing platforms. The processing circuit 102 may include or have access to a local database or parameter storage that can maintain operational parameters and other information used to configure and operate apparatus 100. The local database may be implemented using one or more of a database module, flash memory, magnetic media, EEPROM, optical media, tape, soft or hard disk, or the like. The processing circuit may also be operably coupled to external devices such as the antennas 108, a display 120, operator controls, such as a button 124 and/or an integrated or external keypad 122, among other components.

### Overview of the RFFE Bus

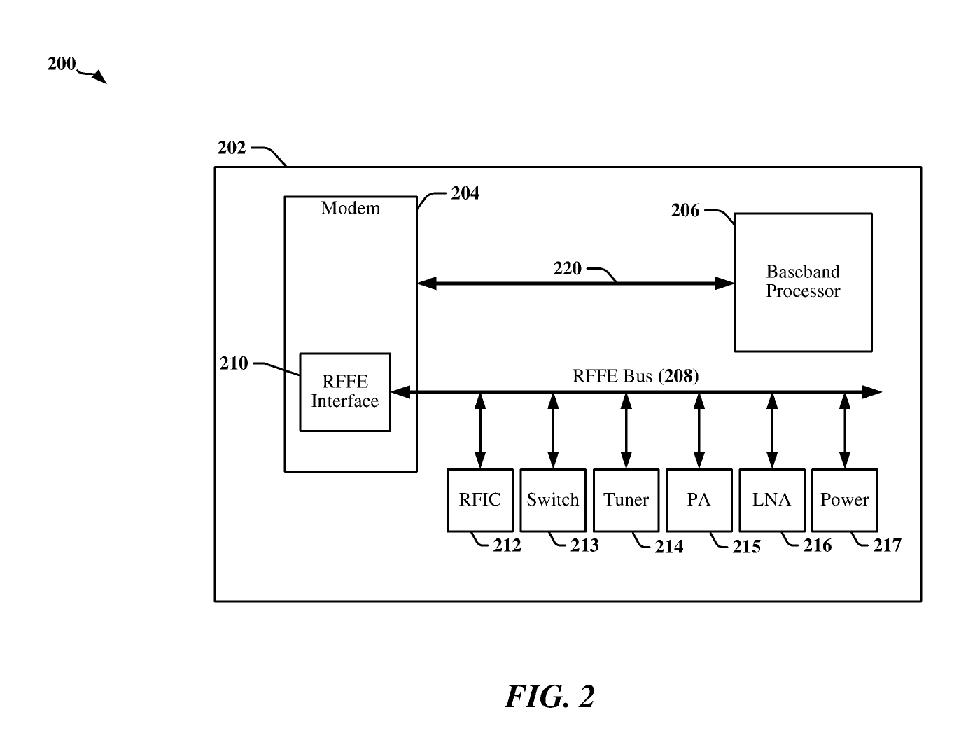

FIG. 2 is a block diagram 200 illustrating an example of a device 202 that employs an RFFE bus 208 to couple various front-end devices 212-217. A modem 204 including an RFFE interface 210 may also be coupled to the RFFE bus 208. In various examples, the device 202 may be implemented with one or more baseband processors 206, one or more other communication links 220, and various other buses, devices and/or different functionalities. In the example, the modem 204 may communicate with a baseband processor 206, and the device 202 may be embodied in one or more of a mobile computing device, a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, avionics systems, a wearable computing device (e.g., a smart watch, a health or fitness tracker, eyewear, etc.), an appliance, a sensor, a security device, a vending machine, a smart meter, a drone, a multicopter, or any other similar functioning device.

The RFFE bus 208 may be coupled to an RF integrated circuit (RFIC) 212, which may include one or more controllers, and/or processors that configure and control certain aspects of the RF front-end. The RFFE bus 208 may couple the RFIC 212 to a switch 213, an RF tuner 214, a power amplifier (PA) 215, a low noise amplifier (LNA) 216, and a power management module 217.

In an example, the baseband processor 206 may be a master device. The master device/baseband processor 206 may drive the RFFE bus 208 to control the various front-end devices 212-217. During transmission, the baseband processor 206 may control the RFFE interface 210 to select the power amplifier 215 for a corresponding transmission band. In addition, the baseband processor 206 may control the switch 213 so that the resulting transmission may propagate from an appropriate antenna. During reception, the baseband processor 206 may control the RFFE interface 210 to receive from the low noise amplifier 216 depending on the corresponding transmission band. It will be appreciated that numerous other components may be controlled through the RFFE bus 208 in this fashion such that the device 202 is merely representative and not limiting. Moreover, other devices such as the RFIC 212 may serve as an RFFE master device in alternative embodiments.

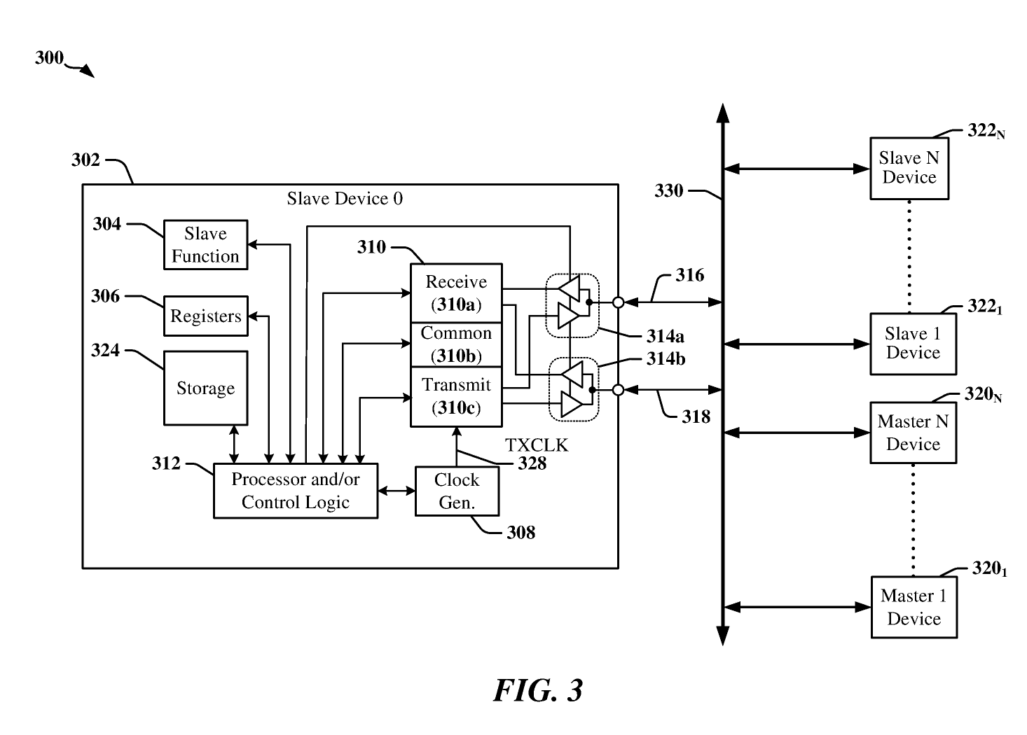

FIG. 3 is a block schematic diagram illustrating an example of an architecture for a device 300 that may employ an RFFE bus 330 to connect bus master devices 320₁-320_{N} and slave devices 302 and 322₁-322_{N}. The RFFE bus 330 may be configured according to application needs, and access to multiple buses 330 may be provided to certain of the devices 320₁-320_{N}, 302, and 322₁-322_{N}. In operation, one of the bus master devices 320₁-320_{N} may gain control of the bus and transmit a slave identifier (slave address) to identify one of the slave devices 302 and 322₁-322_{N} to engage in a communication transaction. Bus master devices 320₁-320_{N} may read data and/or status from slave devices 302 and 322₁-322_{N}, and may write data to memory or may configure the slave devices 302 and 322₁-322_{N}. Configuration may involve writing to one or more registers or other storage on the slave devices 302 and 322₁-322_{N}.

In the example illustrated in FIG. 3, a first slave device 302 coupled to the RFFE bus 330 may respond to one or more bus master devices 320₁-320_{N}, which may read data from, or write data to the first slave device 302. In one example, the first slave device 302 may include or control a power amplifier (see the PA 215 in FIG. 2), and one or more bus master devices 320₁-320_{N} may from time-to-time configure a gain setting at the first slave device 302.

The first slave device 302 may include RFFE registers 306 and/or other storage devices 324, a processing circuit and/or control logic 312, a transceiver 310 and an interface including a number of line driver/receiver circuits 314a, 314b as needed to couple the first slave device 302 to the RFFE bus 330. e.g., via a serial clock line (SCLK) 316 and a serial data line (SDATA) 318. The processing circuit and/or control logic 312 may include a processor such as a state machine, sequencer, signal processor or general-purpose processor. The interface may be implemented using the state machine. Alternatively, the interface may be implemented in software on a suitable processor if included in the first slave device 302. The transceiver 310 may include one or more receivers 310a, one or more transmitters 310c and certain common circuits 310b, including timing, logic and storage circuits and/or devices. In some instances, the transceiver 310 may include encoders and decoders, clock and data recovery circuits, and the like. A transmit clock (TXCLK) signal 328 may be provided to the transmitter 310c, where the TXCLK signal 328 can be used to determine data transmission rates.

The RFFE bus 330 is typically implemented as a serial bus in which data is converted from parallel to serial form by a transmitter, which transmits the encoded data as a serial bitstream. A receiver processes the received serial bitstream using a serial-to-parallel convertor to deserialize the data. The serial bus may include two or more wires, and a clock signal may be transmitted on one wire with serialized data being transmitted on one or more other wires. In some instances, data may be encoded in symbols, where each bit of a symbol controls the signaling state of a wire of the RFFE bus 330.

To control the slave devices 302 and 322₁-322_{N}, a master device (e.g., one of master devices 320₁-320_{N}) either writes or reads to RFFE registers within the slave devices, e.g., the RFFE registers 306 within the first slave device 302. The RFFE registers 306 may be arranged according to an RFFE register address space that ranges from a zeroth (0) address to a 65535 address. In other words, each slave device may include up to 65.536 registers. To address such a number of registers, 16 register address bits for each of the slave devices 302 and 322₁-322_{N} are required. The master device may read from or write to the registers 306 in each slave device using one of the three types of commands discussed above (register command, extended register command, or extended register long command). For example, the register command addresses only the first 32 registers 306 in the address space for each of the slave devices 302 and 322₁-322_{N}. In this fashion, the register command requires only five register address bits. In contrast, the extended register command may initially access up to the first 256 registers in each of the slave devices 302 and 322₁-322_{N}. A corresponding 8-bit register address for the extended register command acts as a pointer in that the data payload for the extended register command may include up to 16 bits. A corresponding read or write operation for an extended register command may thus extend across 16 registers starting from the register identified by the 8-bit register address. The extended register long command includes a 16-bit register address which may act as a pointer to any of the possible 65,536 registers in each slave device. The data payload for an extended register long command may include up to eight bytes so that the corresponding read or write operation for the extended register long command may extend across eight registers starting from the register identified by the 16-bit address. In an aspect of the disclosure, up to 15 slave devices may be coupled to one RFFE bus. If a front end includes more than 15 slave devices, additional RFFE busses may be provided.

### Exemplary High Data Rate (HDR) Operating Environment for Radio Frequency Front End (RFFE) Devices

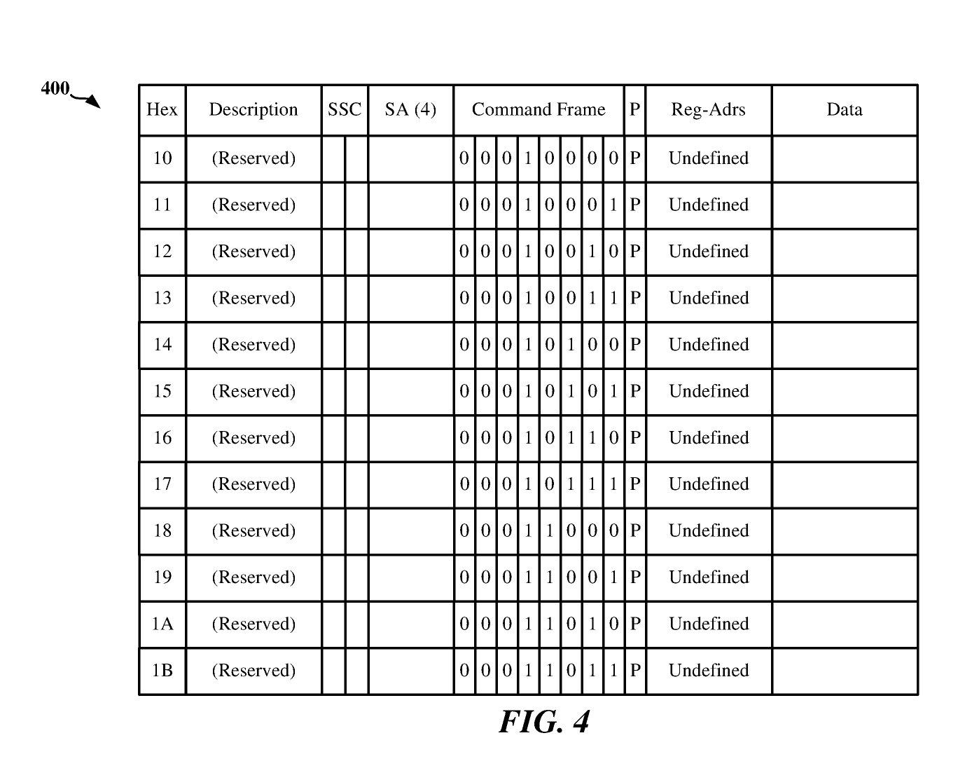

FIG. 4 is a diagram illustrating reserved command fields in an RFFE protocol. To reduce the latency of conventional RFFE command transmissions over the RFFE bus 208, new command frames are provided herein that invoke a mixed single data rate (SDR)/high data rate (HDR) mode of transmission. Hereinafter, the mixed SDR/HDR mode of transmission may be referred to as simply the HDR mode of transmission. The following discussion will assume that the HDR mode of transmission corresponds to a double data rate (DDR) mode of transmission, however, it will be appreciated that ternary or higher order modulation schemes may also be used to increase the data rate transmission in alternative single data rate embodiments. To provide these new command frames, the reserved command frames established by the RFFE protocol are exploited. In that regard, the RFFE protocol reserved at least 12 command frames 400 as shown in FIG. 4 ranging from a reserved command frame at hexadecimal 10 to a reserved command frame at hexadecimal 1B. Each reserved command frame begins with a sequence start condition (SSC) followed by a four-bit slave device address (SA (4)) as shown in FIG. 4. Each reserved command is eight bits long. For example, the reserved command at hexadecimal 10 comprises the eight bits 00010000. All of the reserved commands are followed by a parity bit P followed by address (Reg-Adrs) and data frames for reserved purposes.

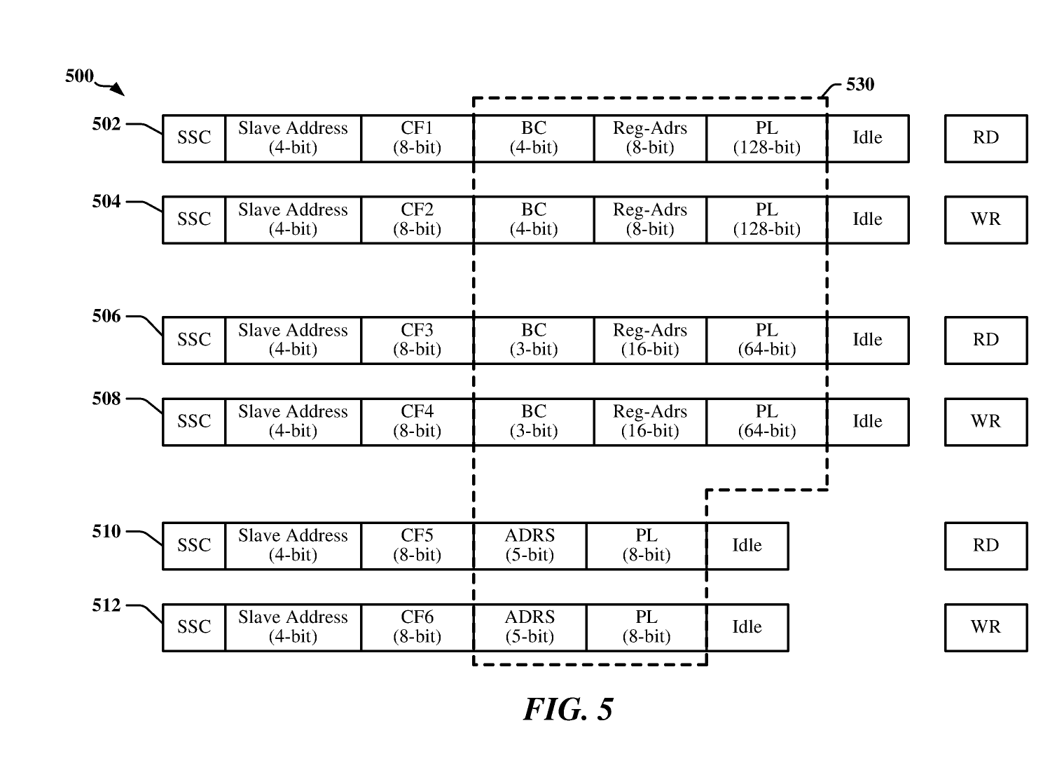

FIG. 5 is a diagram 500 illustrating six reserved commands used to signal an HDR mode of operation. To signal the use of an HDR mode of operation, six of the reserved command frames (designated as command frames CF1 through CF6) may be used to identify enhanced RFFE commands as shown in FIG. 5. For example, an extended register read command 502 begins with an SSC followed by a 4-bit slave device address SA (4). An 8-bit command frame CF1 taken from one of the reserved command frames 400 discussed with regard to FIG. 4 identifies command 502 to the receiving slave device interface. The command frame CF1 is followed by a byte count field (BC) that identifies how many bytes (up to 16 possible) that may be included in the subsequent data frames or payload PL (128-bit). An 8-bit address (Reg-Adrs (8-bit)) identifies the address of the register in the corresponding slave device where the extended read operation begins. An idle symbol (bus park cycle (BPC)) completes command 502. Note that the byte count field, 8-bit address, and data frames PL (128-bit) are included in conventional extended register read commands as defined by the RFFE protocol. However, the command frame CF1 triggers the receiving slave device interface to transition into the HDR mode of operation with regard to the communication of the byte count field, the 8-bit register address, and the data frames in the corresponding slave device interface. An extended register write command 504 is analogous to the extended register read command 502 except that the command frame CF1 is replaced with a command frame CF2 taken from the reserved command frames 400 discussed with regard to FIG. 4.

An extended register long read command 506 also begins with an SSC and the four-bit slave address SA(4), but is followed by a unique command frame CF3 taken from the reserved command frames 400. The command frame CF3 is followed by a 3-bit byte count field (BC (3-bit)), a 16-bit register address (Reg-Adrs (16-bit)), and a data payload (PL (64-bit)) that may be up to eight bytes long depending on the byte count. The byte count field, the register address, and the data payload are all communicated over the RFFE bus 330 (FIG. 3) at the high data rate speed. An extended register long write command 508 is analogous to the extended register long read command 506 except that the command frame CF3 is replaced with another reserved command frame CF4.

A register read command 510 also begins with an SSC and the slave address field SA(4) followed by a unique reserved command frame CF5. The reserved command frame CF5 is followed by a 5-bit register address (ADRS (5-bit)) and an 8-bit data payload (PL (8-bit)). An idle symbol completes the command 510. In command 510, the register address and the data payload are transmitted using the HDR mode. Finally, a register write command 512 is analogous to the register read command 510 except that a reserved command frame CF6 replaces the reserved command frame CF5.

Each of commands 502, 504, 506, 508, 510, and 512 thus includes an HDR portion 530 that is transmitted using the HDR mode. In the extended and extended long commands 502, 504, 506, and 508, each HDR portion 530 includes the byte count, the register address, and the data payload. Since there is no byte count in a register read command 510 or a register write command 512, their HDR portion 530 includes only the register address and the data payload. In an aspect of the disclosure, a master device interface and a slave device interface may be configured to transmit and receive on the SDATA line 318 of the RFFE bus 330 in both a single data rate mode of operation and in a HDR mode of operation. In this fashion, latency is markedly reduced as compared to a conventional operation.

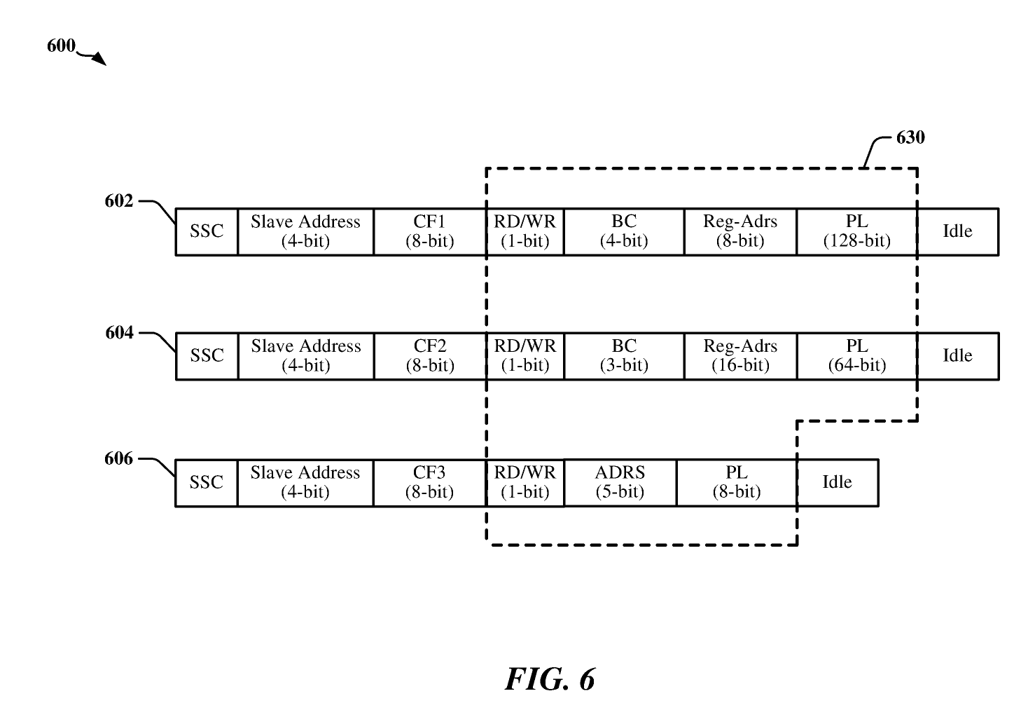

FIG. 6 is a diagram illustrating a modification of the reserved commands used to signal an HDR mode of operation of FIG. 5. Rather than use six of the reserved command frames, just three reserved command frames may be used for generic read/write HDR commands 600 as shown in FIG. 6. All of the commands 600 begin with an SSC, followed by a slave address SA (4-bit), and end with an idle symbol. A generic extended register HDR command 602 uses a reserved command frame CF1 that is followed by a read/write bit (RD/WR (1-bit)) to signify whether an extended register read or write HDR command is intended. The command 602 includes an HDR portion 630 that includes the read/write bit as well as the byte count (BC), the 8-bit register address, and the data payload that may range up to 16 bytes depending on the byte count. A generic extended register long HDR command 604 uses a reserved command field CF2. The command 604 also includes a read/write (RD/WR) bit to signify whether a read or write operation is intended beginning at a 16-bit register address. A 3-bit byte count (BC) determines the number of bytes (up to eight) that may be included in the data payload PL (64-bit). An HDR portion 630 in the command 604 includes the read/write (RD/WR) bit, the byte count (BC), the register address, and the data payload. To maintain uniformity with a current RFFE structure, the RD/WR and the BC mentioned above may have a combined bit length of eight bits (8-bit) followed by a parity bit (not shown as it is implicitly understood). Finally, a generic register HDR command 606 includes a reserved command field CF3. The HDR portion 630 for the command 606 includes the read/write (RD/WR) bit, the 5-bit register address, and the 8-bit data payload.

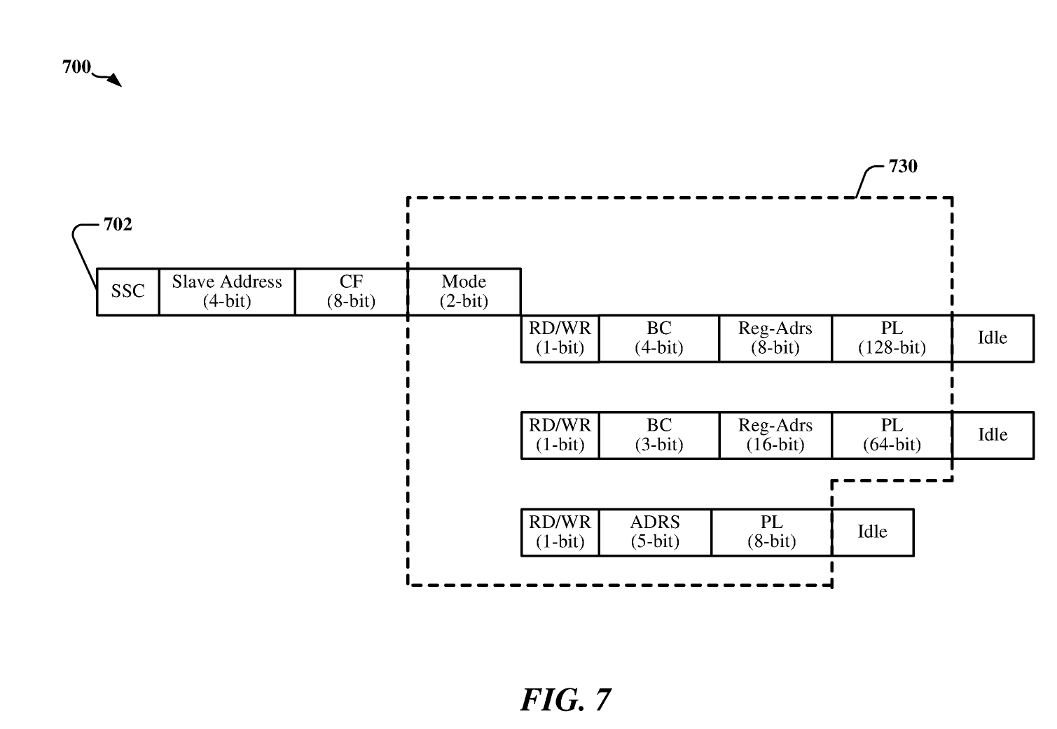

FIG. 7 is a diagram 700 illustrating a modification of the reserved commands used to signal an HDR mode of operation of FIG. 6. The number of reserved commands may be reduced even further as shown in FIG. 7 for a generic HDR command 702 that includes a reserved command field CF. An HDR portion 730 in the command 702 includes a 2-bit mode field to identify whether an extended register, an extended register long, or a register command is indicated. As discussed with regard to the HDR portion 630, a read/write bit identifies whether a read or write operation is indicated. The HDR portion 730 thus includes the 2-bit mode field, the read/write bit, the byte count (for extended register and extended register long commands), the register address, and the data payload.

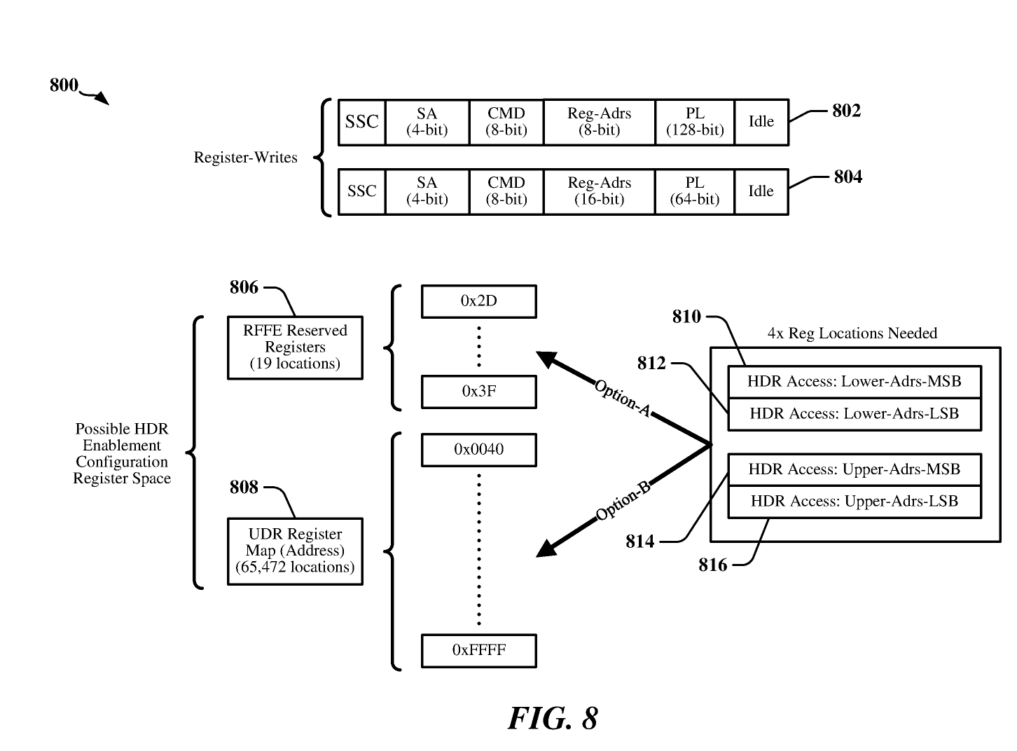

FIG. 8 is a diagram 800 illustrating high data rate (HDR) enablement. The discussion below assumes that the HDR mode includes the DDR mode and other higher order modulation schemes. Accordingly, aspects described below with respect to the HDR mode may also apply to the DDR mode and other higher order modulation schemes in general. According to the technique depicted in FIG. 8, HDR writing may be enabled without the need for a new type of command code or additional datagram bits associated with a new type of command code. In an aspect of the disclosure, HDR writing may be enabled using existing register-write commands, e.g., extended register-write command 802 and extended register-write long command 804.

At a master device and a slave device, address registers may have distinct regions. For example, a first region 806 may include the registers 0x2D to 0x3F in hexadecimal, thus having 19 register locations. The first region 806 having the 19 register locations may be referred to as RFFE reserved registers. A second region 808 includes the registers 0x0040 to 0xFFFF in hexadecimal, thus having 65472 register locations. The second region 808 having the 65472 register locations may be referred to as a User Defined Registers (UDR) Register Map.

In an aspect of the disclosure, the first region 806 and/or the second region 808 may be used as an HDR enablement configuration register space. In an example, a range of registers within the first region 806 or the second region 808 may be reserved for enabling HDR writing. That is, a register address range may be bound within the first region 806 or the second region 808 to define an HDR access region where high speed access is applicable. The register address range may be bound by reserving four registers located in either the first region 806 or the second region 808. In an example, for a maximum 16-bit register address, a lower address value (lower bound) of the HDR access region may be stored in a first lower address register 810 and a second lower address register 812. For example, a most significant byte (MSB) of the lower address value may be stored in the first lower address register 810 and a least significant byte (LSB) of the lower address value may be stored in the second lower address register 812. An upper address value (upper bound) of the HDR access region may be stored in a first upper address register 814 and a second upper address register 816. For example, a MSB of the upper address value may be stored in the first upper address register 814 and a LSB of the upper address value may be stored in the second upper address register 816.

Once the HDR access region is defined, any time a transmitter generates a datagram to be sent to a particular register address, the transmitter will detect whether the payload to be sent is for a register address that falls within the bounded address limits of the defined HDR access region. If the register address indeed falls within the HDR access region, then the transmitter will know to use a high data rate technique to send the payload. The transmitter may begin transmitting data (payload) at the high data rate from a point after detecting that the register address falls between the bounded address limits.

From a receiver point of view, the receiver will first receive the register address from the transmitter according to single data rate (SDR) mode. Thereafter, the receiver will detect whether to decode incoming data (payload) associated with the register address according to a SDR mode or a HDR mode based on whether the received register address falls within the bounded address limits of the defined HDR access region.

According to aspects of the disclosure, because the HDR access region may be defined, the transmitter and receiver may avoid subjecting certain address registers in a register space to a high data rate by excluding such registers in an HDR access address range when defining the HDR access region of the register space.

Benefits of the scheme described above include no new command code being needed to enable HDR access and no additional datagram bits being needed to indicate HDR parameters. Also, the changeover from a high data rate to a low data rate occurs automatically. That is, the changeover is purely defined by the register region marked for high data rate access.

As mentioned above, the HDR mode includes the DDR mode and other higher order modulation schemes. Accordingly, aspects of the disclosure described below regarding the DDR mode may also apply to the HDR mode in general.

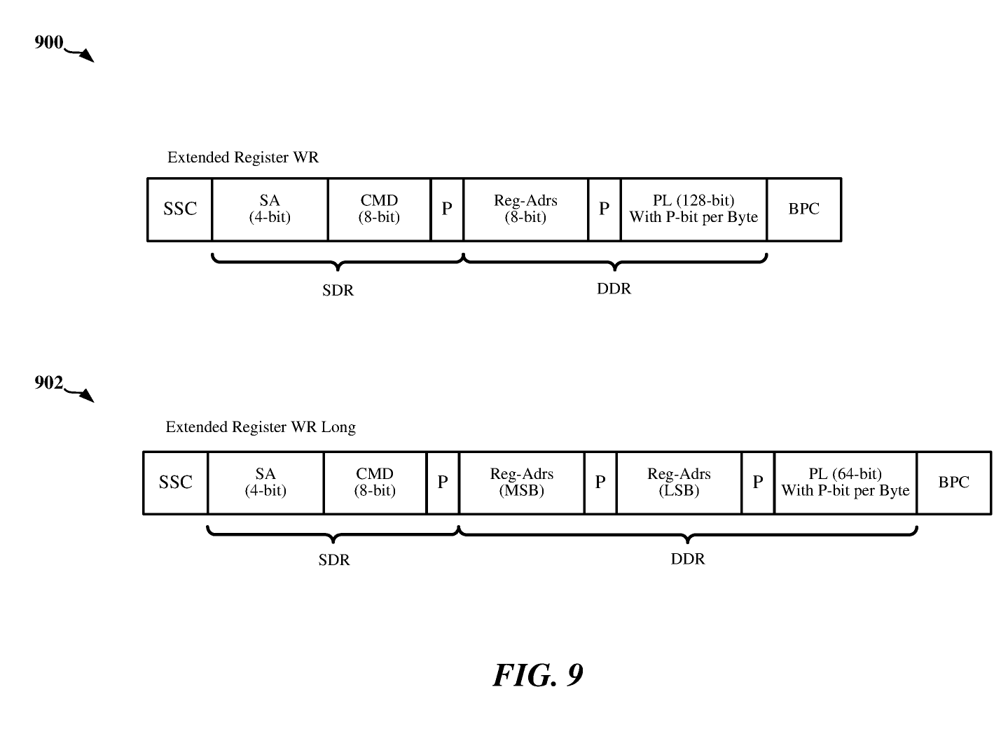

FIG. 9 illustrates diagrams 900 and 902 of RFFE mixed-mode write datagrams. RFFE datagrams operate in SDR mode. To decrease bus latency, DDR mode (or HDR mode) support is valuable. The DDR mode effectively doubles the bandwidth while keeping a clock rate the same as in SDR mode. This has the advantage of mitigating board-level signal integrity issues.

In another aspect of the disclosure, an architecture is provided that enables a mixed SDR/DDR mode of operation for RFFE without requiring any dedicated command code. Hereinafter, the mixed SDR/DDR mode may be referred to as simply the DDR mode. Enabling or disabling of the DDR mode may be achieved by enabling or disabling a single configuration bit within a configuration register, e.g., register 0x18 in hexadecimal.

Referring to FIG. 9, the RFFE DDR mode may be used for an extended register-write operation 900 and an extended register-write long operation 902. Once the DDR mode is enabled, the bus transmission latency of both the extended register-write operation and the extended register-write long operation is reduced. In the DDR mode, the header of a datagram (e.g., SA, CMD, and parity P) is transmitted in the SDR mode and the remaining portion of the datagram (e.g., Reg-Adrs and payload PL) is transmitted in the DDR mode.

An example motivation for the DDR mode is that if only one device needs its bus latency to be reduced, then the one device can contain the cost of the extra logic to enable the DDR mode of operation. Thus, the device supporting the DDR mode can co-exist on the same bus with another device that does not support the DDR mode.

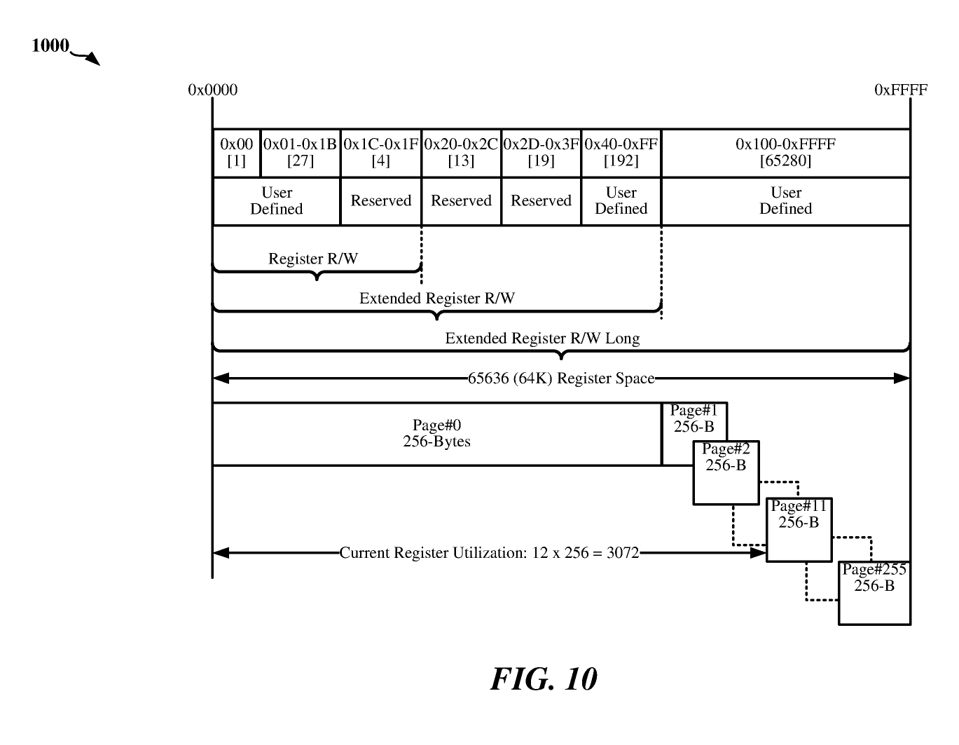

FIG. 10 is a diagram of an RFFE register space 1000. The RFFE register space 1000 may extend from register 0x0000 to register 0xFFFF in hexadecimal.

An association of commands in terms of register space accessibility is shown in FIG. 10. The reach of an extended register operation may be limited to the space between the 0x00 register and the 0xFF register. However, a complex RFFE slave may contain multiple pages (each having 0x00 to 0xFF 1-byte locations) within the 64K register space, and therefore, enable extended register operation to access the entire 64K register space and reduce bus latency. To achieve this, the 64K register space may be segmented into 256 pages (pages 0x00 to 0xFF), each containing 256 register locations. An 8-bit register address in a datagram combined with a page address allows any register access within the 64K space. The page address may be stored at a known register location and may be combined as an address-MSB with the datagram-supplied 8-bit register address (address-LSB). This may be the basis for page segmented access for an extended register operation.

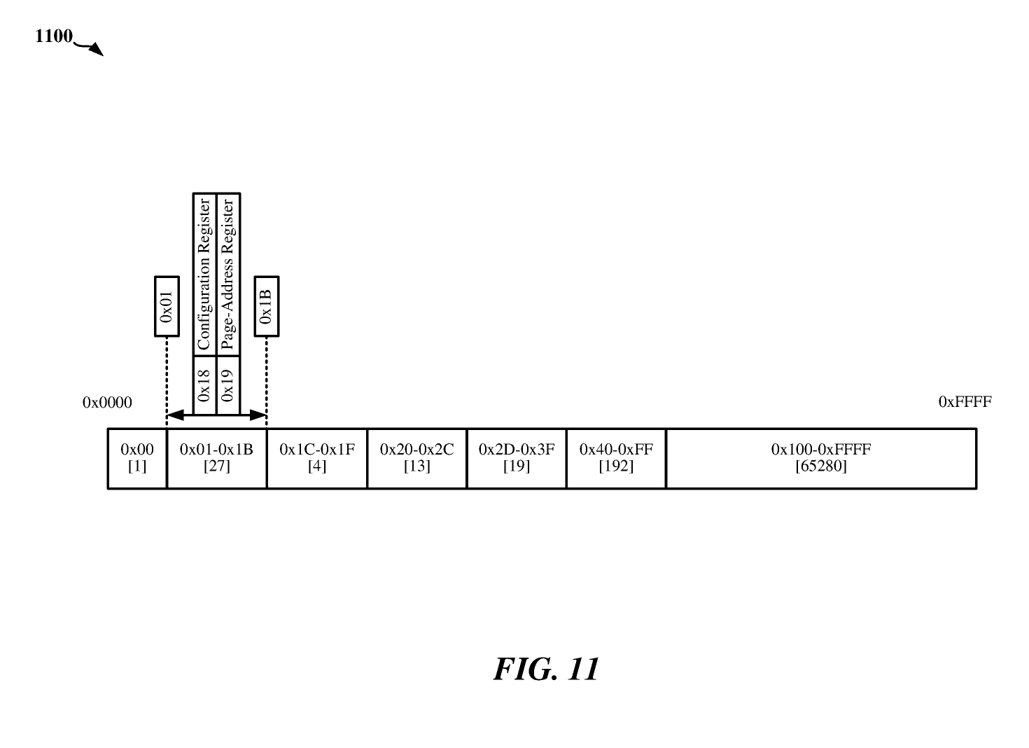

FIG. 11 is a diagram of an RFFE register space 1100 having a configuration register and a page-address register. To facilitate the enabling and disabling of various features, an 8-bit configuration register may be used. The configuration register and a page-address register may use two specific registers in the register space that are register-mode accessible. For example, as shown in FIG. 11, the configuration register may be defined at location 0x18 and the page-address register may be defined at location 0x19 in the register space. Both the 0x18 and 0x19 locations are in a user defined space.

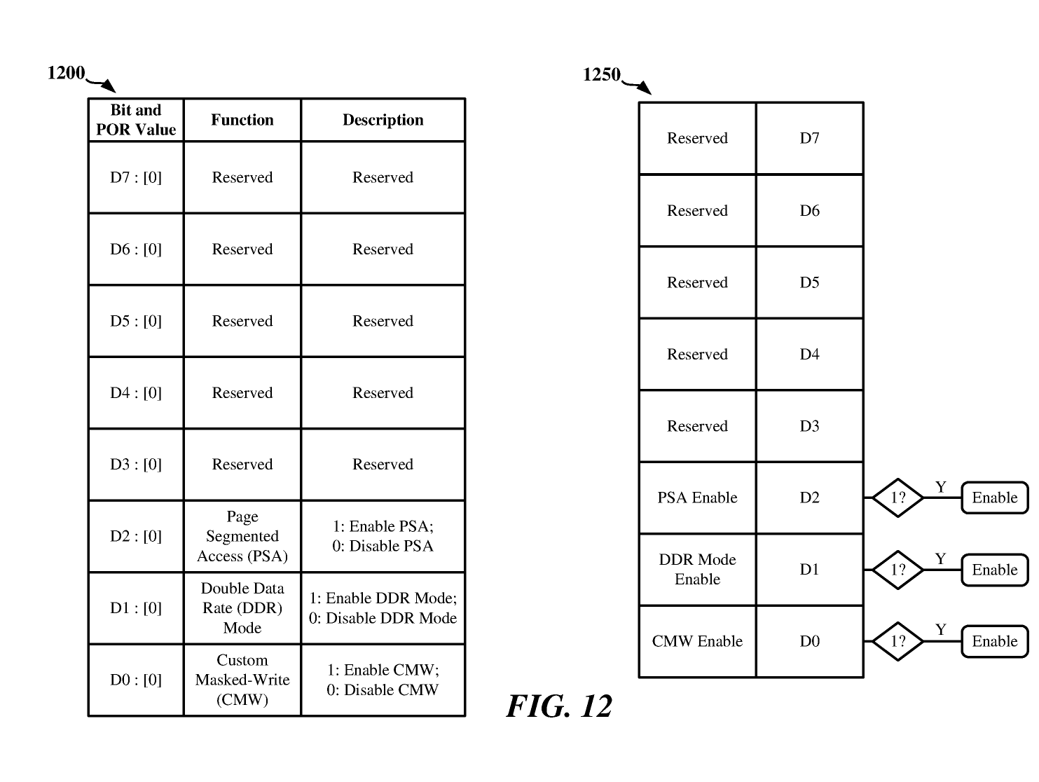

FIG. 12 illustrates a table 1200 defining configuration register bits and a diagram 1250 depicting a function of the configuration register bits. A configuration register containing bit locations D7 to D0 may be defined at register location 0x18. Referring to table 1200 and diagram 1250, page segmented access (PSA) may be enabled or disabled by enabling (e.g., setting to “1”) or disabling (e.g., setting to “0”) the configuration bit at bit location D2. A double data rate (DDR) mode may be enabled or disabled by enabling or disabling the configuration bit at bit location D1. Additionally, custom masked-write (CMW) may be enabled or disabled by enabling or disabling the configuration bit at bit location D0. For D0, D1, and D2, a configuration bit value of “1” implies that a corresponding function is enabled while a configuration bit value of “0” implies that the corresponding function is disabled.

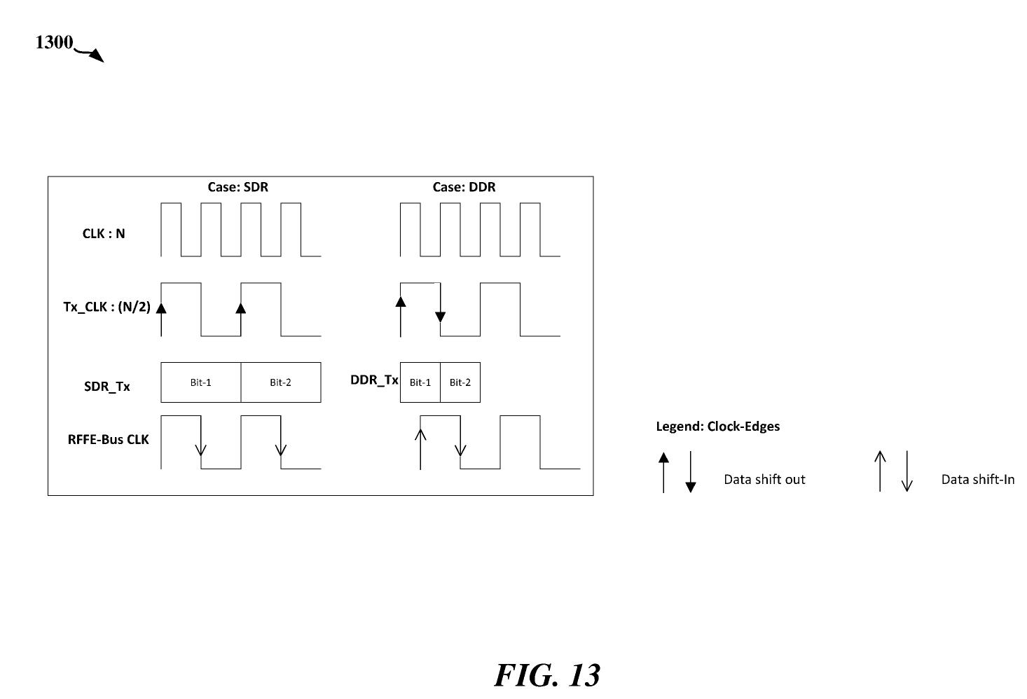

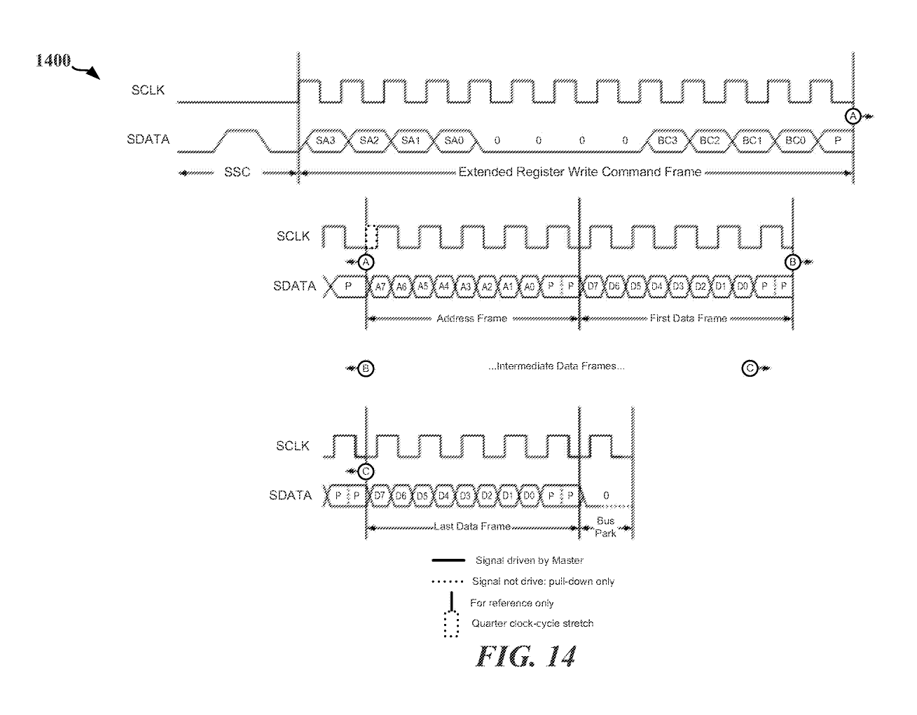

FIG. 13 is a diagram 1300 illustrating a relationship between clock and data with respect to the SDR and DDR modes of data transmission. FIG. 14 illustrates a DDR mode RFFE write timing diagram 1400. Clock frequency as seen on the RFFE clock line is the same for both the SDR mode and the DDR mode. The difference between the two modes will be explained below.

In the SDR Mode, Tx_CLK, which is produced by dividing the reference clock by two is used to shift data out. The data is transmitted on positive edges. The same Tx_CLK is sent out as the RFFE bus clock and is used by the receiver to latch incoming data on its negative edges. Thus, the data bits are ideally sampled at the center point of the transmitted bits.

In the DDR mode, Tx_CLK, which is produced by dividing the reference clock by two is used to shift data out. The data is transmitted on both positive and negative edges. The RFFE bus clock is generated by shifting the Tx_CLK by 90-degrees (quarter cycle) and is used by the receiver to latch incoming data on both its positive and negative edges. Thus, the data bits are ideally sampled at the center point of the transmitted bits.

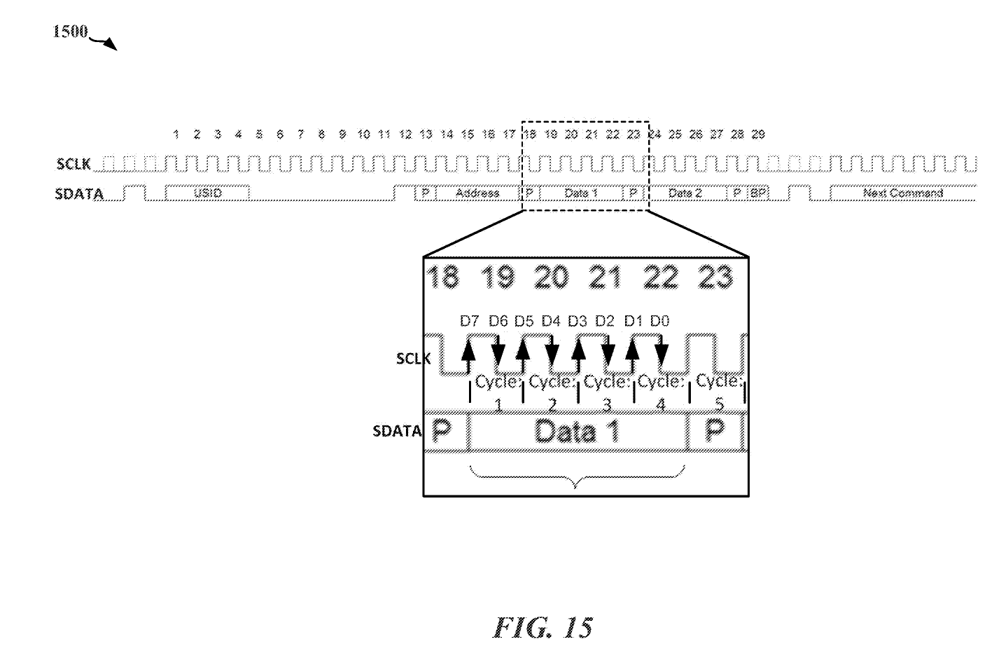

FIG. 15 is a diagram 1500 illustrating use of a parity bit occupying a full clock cycle in the DDR section of a datagram. In the DDR mode, based on the number of data byte used in the payload, the number of bits transmitted may be even or odd. This means that the clock edge last used to latch-in the data in the two possible cases (SDR mode or DDR mode) may be either positive (odd number of bits) or negative (even number of bits). The unpredictability of the clock edge for the last bit latched-in may complicate the implementation of a bus park cycle (BPC).

The complexity of implementing the BPC along with data latching may be simplified by using a parity bit which occupies one full clock cycle after every 8-bits of data. This way, regardless of the number of bytes used in the payload, the number of bits transmitted in the DDR section of the datagram remains even and the last clock edge used to latch-in the data is a negative edge.

As shown in FIG. 15, after every byte of data, a parity bit P may occupy one full cycle whereas each address or data bit occupies only a half-cycle. The use of the parity bit P occupying a full clock cycle increases the effective bit count in the DDR section of the datagram by approximately 11%, and thus positively impacts a corresponding latency.

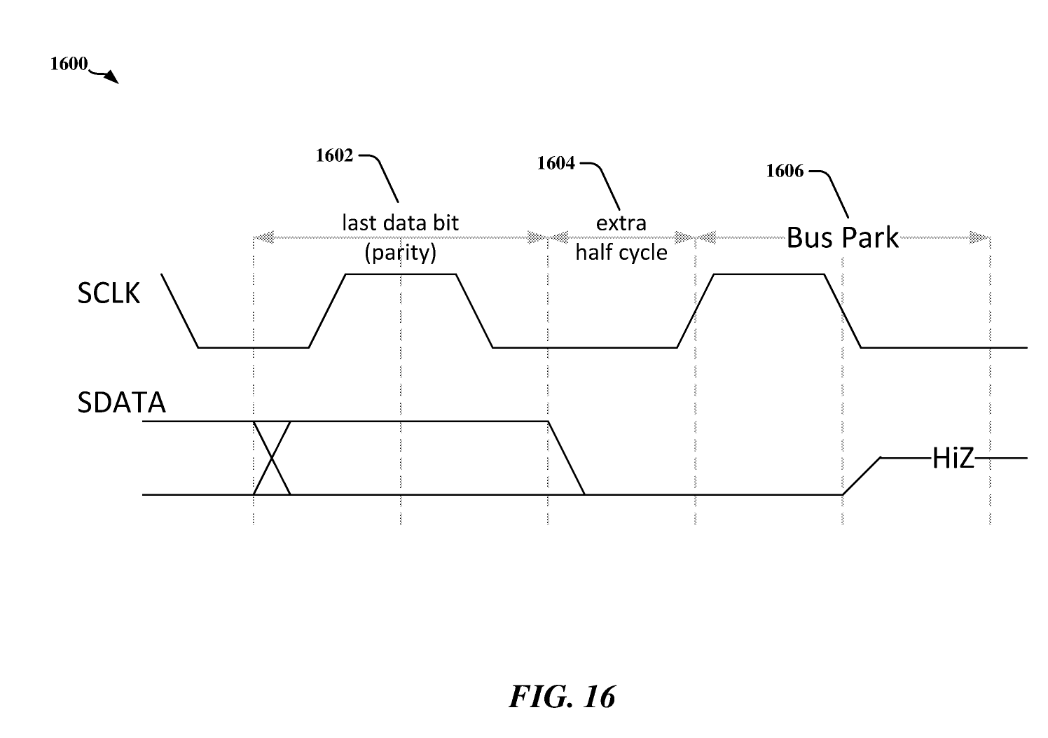

FIG. 16 is a diagram 1600 illustrating a bus park cycle (BPC) at the end of a DDR section of a datagram. A DDR transition BPC is depicted. Since the use of the parity bit P occupying a full clock cycle guarantees an even number of bits transmitted in the DDR section, the last bit 1602 is always latched-in at a negative edge. The clock may be held low for an extra half cycle 1604. Following this, a rising clock edge and a falling clock edge occur in the BPC 1606 to comply with the existing RFFE standard for BPC timing.

### Example of Hardware Implementation

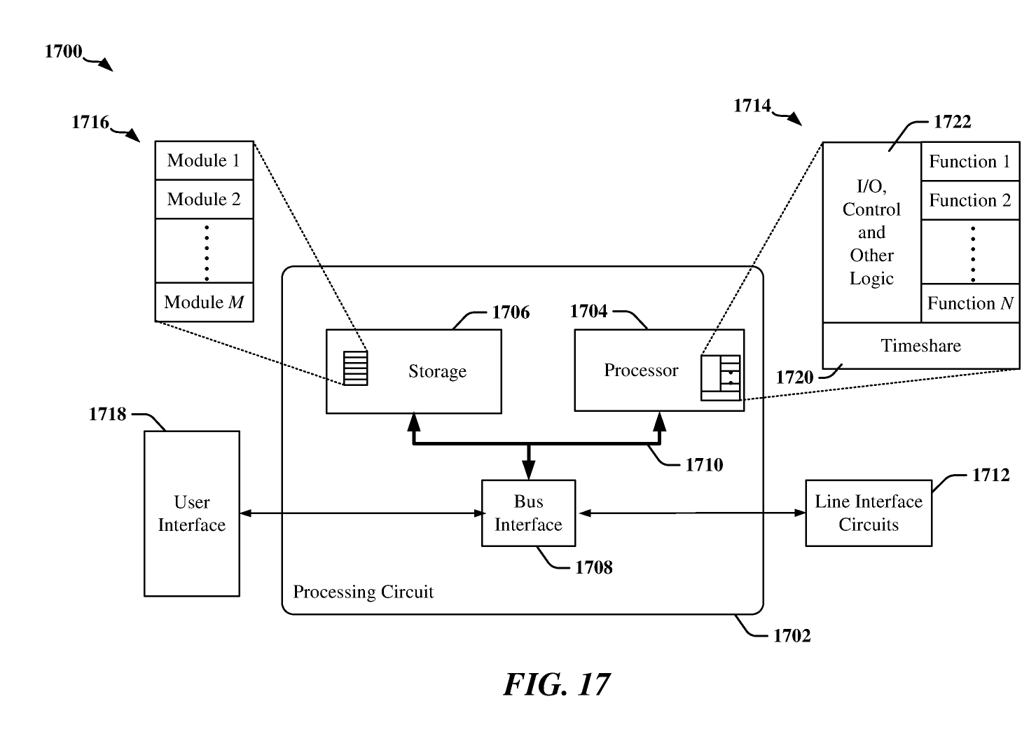

FIG. 17 is a conceptual diagram illustrating a simplified example of a hardware implementation for an apparatus 1700 employing a processing circuit 1702 that may be configured to perform one or more functions disclosed herein. In accordance with various aspects of the disclosure, an element, or any portion of an element, or any combination of elements as disclosed herein may be implemented using the processing circuit 1702. The processing circuit 1702 may include one or more processors 1704 that are controlled by some combination of hardware and software modules. Examples of processors 1704 include microprocessors, microcontrollers, digital signal processors (DSPs), ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1704 may include specialized processors that perform specific functions, and that may be configured, augmented or controlled by one of the software modules 1716. The one or more processors 1704 may be configured through a combination of software modules 1716 loaded during initialization, and further configured by loading or unloading one or more software modules 1716 during operation.

In the illustrated example, the processing circuit 1702 may be implemented with a bus architecture, represented generally by the bus 1710. The bus 1710 may include any number of interconnecting buses and bridges depending on the specific application of the processing circuit 1702 and the overall design constraints. The bus 1710 links together various circuits including the one or more processors 1704, and storage 1706. Storage 1706 may include memory devices and mass storage devices, and may be referred to herein as computer-readable media and/or processor-readable media. The bus 1710 may also link various other circuits such as timing sources, timers, peripherals, voltage regulators, and power management circuits. A bus interface 1708 may provide an interface between the bus 1710 and one or more line interface circuits 1712. A line interface circuit 1712 may be provided for each networking technology supported by the processing circuit. In some instances, multiple networking technologies may share some or all of the circuitry or processing modules found in a line interface circuit 1712. Each line interface circuit 1712 provides a means for communicating with various other apparatus over a transmission medium. Depending upon the nature of the apparatus 1700, a user interface 1718 (e.g., keypad, display, speaker, microphone, joystick) may also be provided, and may be communicatively coupled to the bus 1710 directly or through the bus interface 1708.

A processor 1704 may be responsible for managing the bus 1710 and for general processing that may include the execution of software stored in a computer-readable medium that may include the storage 1706. In this respect, the processing circuit 1702, including the processor 1704, may be used to implement any of the methods, functions and techniques disclosed herein. The storage 1706 may be used for storing data that is manipulated by the processor 1704 when executing software, and the software may be configured to implement any one of the methods disclosed herein.

One or more processors 1704 in the processing circuit 1702 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1706 or in an external computer readable medium. The external computer-readable medium and/or storage 1706 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1706 may also include, by way of example, a carrier wave, a transmission line, and any other suitable medium for transmitting software and/or instructions that may be accessed and read by a computer. Computer-readable medium and/or the storage 1706 may reside in the processing circuit 1702, in the processor 1704, external to the processing circuit 1702, or be distributed across multiple entities including the processing circuit 1702. The computer-readable medium and/or storage 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1706 may maintain software maintained and/or organized in loadable code segments, modules, applications, programs, etc., which may be referred to herein as software modules 1716. Each of the software modules 1716 may include instructions and data that, when installed or loaded on the processing circuit 1702 and executed by the one or more processors 1704, contribute to a run-time image 1714 that controls the operation of the one or more processors 1704. When executed, certain instructions may cause the processing circuit 1702 to perform functions in accordance with certain methods, algorithms and processes described herein.

Some of the software modules 1716 may be loaded during initialization of the processing circuit 1702, and these software modules 1716 may configure the processing circuit 1702 to enable performance of the various functions disclosed herein. For example, some software modules 1716 may configure internal devices and/or logic circuits 1722 of the processor 1704, and may manage access to external devices such as the line interface circuit 1712, the bus interface 1708, the user interface 1718, timers, mathematical coprocessors, and so on. The software modules 1716 may include a control program and/or an operating system that interacts with interrupt handlers and device drivers, and that controls access to various resources provided by the processing circuit 1702. The resources may include memory, processing time, access to the line interface circuit 1712, the user interface 1718, and so on.

One or more processors 1704 of the processing circuit 1702 may be multifunctional, whereby some of the software modules 1716 are loaded and configured to perform different functions or different instances of the same function. The one or more processors 1704 may additionally be adapted to manage background tasks initiated in response to inputs from the user interface 1718, the line interface circuit 1712, and device drivers, for example. To support the performance of multiple functions, the one or more processors 1704 may be configured to provide a multitasking environment, whereby each of a plurality of functions is implemented as a set of tasks serviced by the one or more processors 1704 as needed or desired. In one example, the multitasking environment may be implemented using a timesharing program 1720 that passes control of a processor 1704 between different tasks, whereby each task returns control of the one or more processors 1704 to the timesharing program 1720 upon completion of any outstanding operations and/or in response to an input such as an interrupt. When a task has control of the one or more processors 1704, the processing circuit is effectively specialized for the purposes addressed by the function associated with the controlling task. The timesharing program 1720 may include an operating system, a main loop that transfers control on a round-robin basis, a function that allocates control of the one or more processors 1704 in accordance with a prioritization of the functions, and/or an interrupt driven main loop that responds to external events by providing control of the one or more processors 1704 to a handling function.

Exemplary Methods and Device for Sending Data from a Transmitter to a Receiver at a High Data Rate

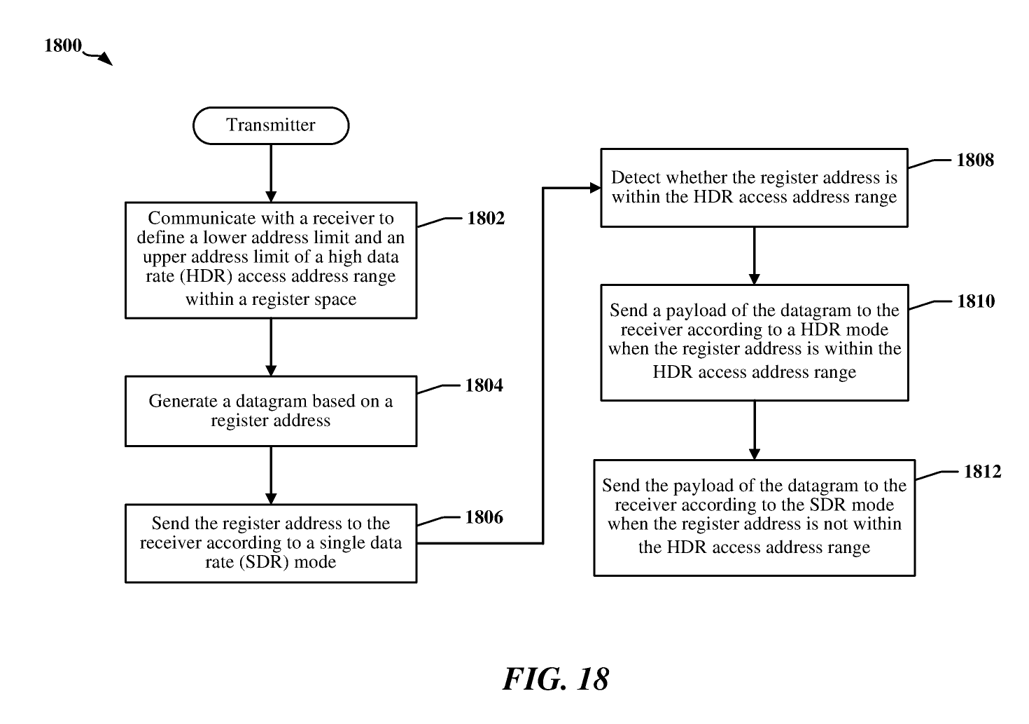

FIG. 18 is a flow chart 1800 of a method for sending data to a receiver across a serial bus interface. The method may be performed at a device operating as a transmitter (e.g., bus master).

The device may communicate with the receiver to define a lower address limit and an upper address limit of a high data rate (HDR) access address range within a register space 1802. The lower address limit may include a most significant byte (MSB) and a least significant byte (LSB). Moreover, the MSB of the lower address limit may be stored in a first lower address register of the register space and the LSB of the lower address limit may be stored in a second lower address register of the register space. The upper address limit may also include a MSB and a LSB. As such, the MSB of the upper address limit may be stored in a first upper address register of the register space and the LSB of the upper address limit may be stored in a second upper address register of the register space.

After the lower and upper limits of the HDR access address range are defined, the device may generate a datagram based on a register address 1804. The device may send the register address to the receiver according to a single data rate (SDR) mode 1806. The device may also detect whether the register address is within the HDR access address range 1808. If the register address is within the HDR access address range, then the device may send a payload of the datagram according to a HDR mode 1810. The HDR mode may include the DDR mode or other higher order modulation schemes. However, if the register address is not within the HDR access address range, then the device may send the payload of the datagram according to the SDR mode 1812.

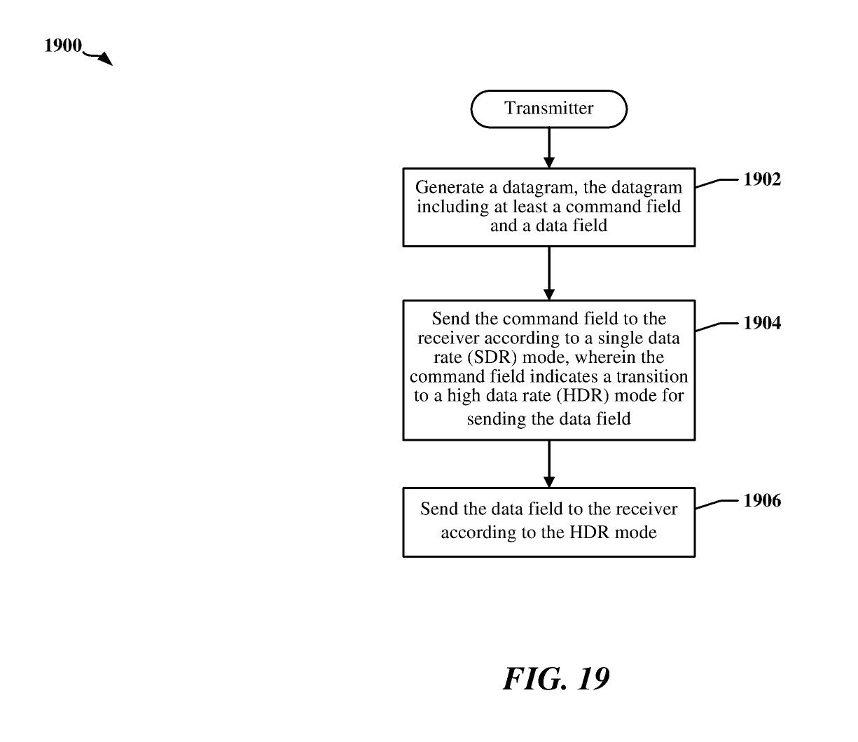

FIG. 19 is a flow chart 1900 of another method for sending data to a receiver across a serial bus interface. The method may be performed at a device operating as a transmitter (e.g., bus master).

The device may generate a datagram 1902, wherein the datagram may include at least a command field and a data field. In an aspect of the disclosure, the command field indicates whether the datagram is related to a read operation or a write operation, and indicates whether the datagram is an extended register command, an extended register long command, or a register command. In another aspect of the disclosure, the datagram includes a read/write indication bit indicating whether the datagram is related to a read operation or a write operation, and the command field indicates whether the datagram is an extended register command, an extended register long command, or a register command. In a further aspect of the disclosure, the datagram includes a read/write indication bit indicating whether the datagram is related to a read operation or a write operation, and includes a mode field indicating whether the datagram is an extended register command, an extended register long command, or a register command.

The device may send the command field to the receiver according to a single data rate (SDR) mode 1904, wherein the command field indicates a transition to a high data rate (HDR) mode for sending the data field. The device may also send the data field to the receiver according to the HDR mode 1906. The HDR mode may include the DDR mode or other higher order modulation schemes.

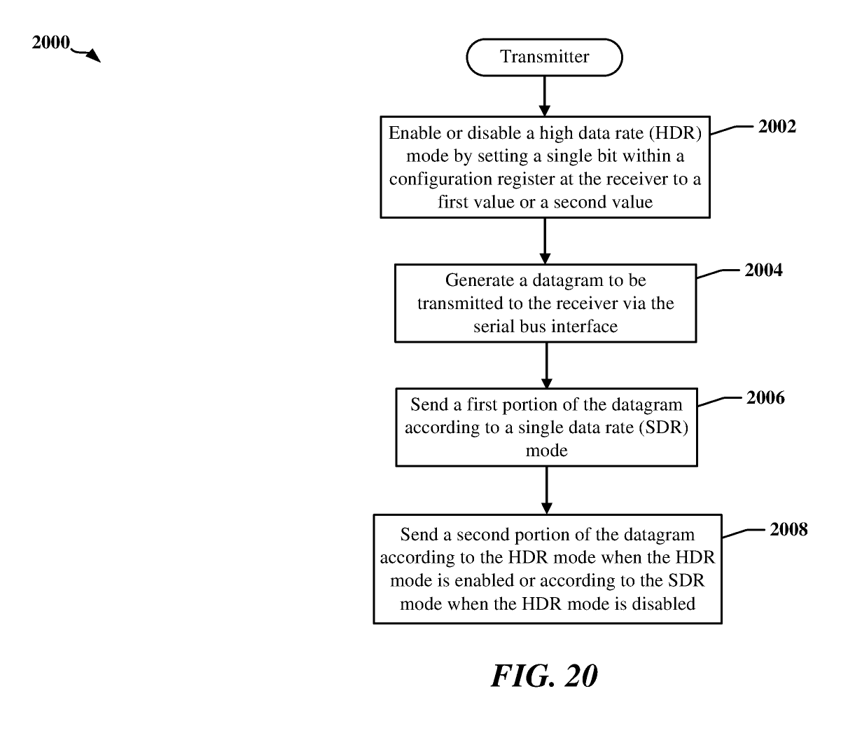

FIG. 20 is a flow chart 2000 of a further method for sending data to a receiver across a serial bus interface. The method may be performed at a device operating as a transmitter (e.g., bus master).

The device may enable or disable a high data rate (HDR) mode by setting a single bit within a configuration register at the receiver to a first value 2002. The HDR mode may include the DDR mode or other higher order modulation schemes. In one example, the HDR mode may be enabled by performing a write operation to the receiver's configuration register (e.g., register at location 0x18) in order to set a bit D1 to a value of “l”. In another example, the HDR mode may be disabled by performing a write operation to the receiver's configuration register (e.g., register at location 0x18) in order to set the bit D1 to a value of “0”.

The device may generate a datagram to be transmitted to the receiver via the serial bus interface 2004. The device may send a first portion of the datagram according to a single data rate (SDR) mode 2006. The device may send a second portion of the datagram according to the HDR mode when the HDR mode is enabled or according to the SDR mode when the HDR mode is disabled 2008. The first portion of the datagram may include a receiver address field and a command field. The second portion of the datagram may include a register address and a payload.

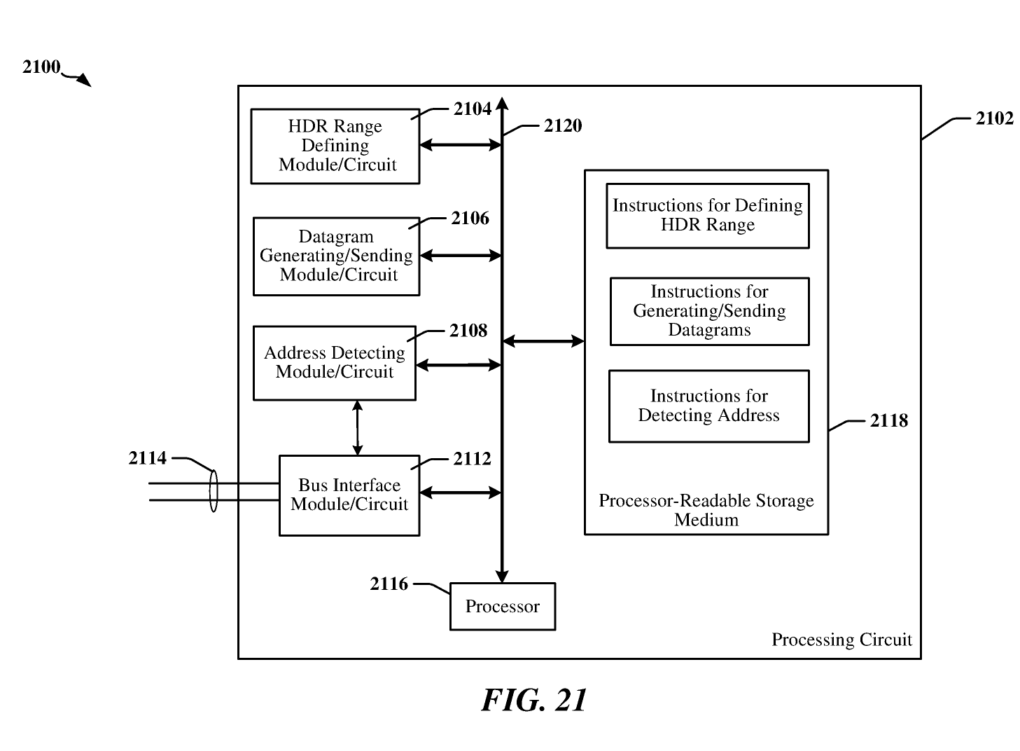

FIG. 21 is a diagram illustrating a simplified example of a hardware implementation for a transmitting apparatus 2100 employing a processing circuit 2102. Examples of operations performed by the transmitting apparatus 2100 include the operations described above with respect to the flow charts of FIGS. 18, 19, and 20. The processing circuit typically has a processor 2116 that may include one or more of a microprocessor, microcontroller, digital signal processor, a sequencer and a state machine. The processing circuit 2102 may be implemented with a bus architecture, represented generally by the bus 2120. The bus 2120 may include any number of interconnecting buses and bridges depending on the specific application of the processing circuit 2102 and the overall design constraints. The bus 2120 links together various circuits including one or more processors and/or hardware modules, represented by the processor 2116, the modules or circuits 2104, 2106, 2108, bus interface circuits 2112 configurable to support communication over connectors or wires 2114 and the computer-readable storage medium 2118. The bus 2120 may also link various other circuits such as timing sources, peripherals, voltage regulators, and power management circuits, which are well known in the art, and therefore, will not be described any further.

The processor 2116 is responsible for general processing, including the execution of software/instructions stored on the computer-readable storage medium 2118. The software/instructions, when executed by the processor 2116, causes the processing circuit 2102 to perform the various functions described supra for any particular apparatus. The computer-readable storage medium may also be used for storing data that is manipulated by the processor 2116 when executing software, including data decoded from symbols transmitted over the connectors or wires 2114, which may be configured as data lanes and clock lanes. The processing circuit 2102 further includes at least one of the modules/circuits 2104, 2106, and 2108. The modules/circuits 2104, 2106, and 2108 may be software modules running in the processor 2116, resident/stored in the computer-readable storage medium 2118, one or more hardware modules coupled to the processor 2116, or some combination thereof. The modules/circuits 2104, 2106, and/or 2108 may include microcontroller instructions, state machine configuration parameters, or some combination thereof.

In one configuration, the apparatus 2100 for communication includes a HDR range defining module/circuit 2104 that is configured to, communicate with a receiver to define a lower address limit and an upper address limit of a high data rate (HDR) access address range within a register space. The apparatus 2100 further includes a datagram generating/sending module circuit 2106 that is configured to, generate a datagram based on a register address, and via the bus interface module/circuit 2112, send the register address to the receiver according to a single data rate (SDR) mode, send a payload of the datagram to the receiver according to a HDR mode when the register address is within the HDR access address range, and send the payload of the datagram to the receiver according to the SDR mode when the register address is not within the HDR access address range. The apparatus 2100 further includes an address detecting module/circuit 2108 that is configured to, detect whether the register address is within the HDR access address range.

In another configuration, the datagram generating/sending module circuit 2106 is configured to, generate a datagram including at least a command field and a data field, send the command field to the receiver according to a single data rate (SDR) mode, wherein the command field indicates a transition to a high data rate (HDR) mode for sending the data field, and send the data field to the receiver according to the HDR mode.

In a further configuration, the datagram generating/sending module circuit 2106 is configured to, enable a high data rate (HDR) mode by setting a single bit within a configuration register at the receiver to a first value, disable the HDR mode by setting the single bit within the configuration register at the receiver to a second value, generate a datagram to be transmitted to the receiver via the serial bus interface, send a first portion of the datagram according to a single data rate (SDR) mode, send a second portion of the datagram according to the HDR mode when the HDR mode is enabled, and send the second portion of the datagram according to the SDR mode when the HDR mode is disabled.

Exemplary Methods and Device for Receiving Data at a Receiver from a Transmitter at a High Data Rate

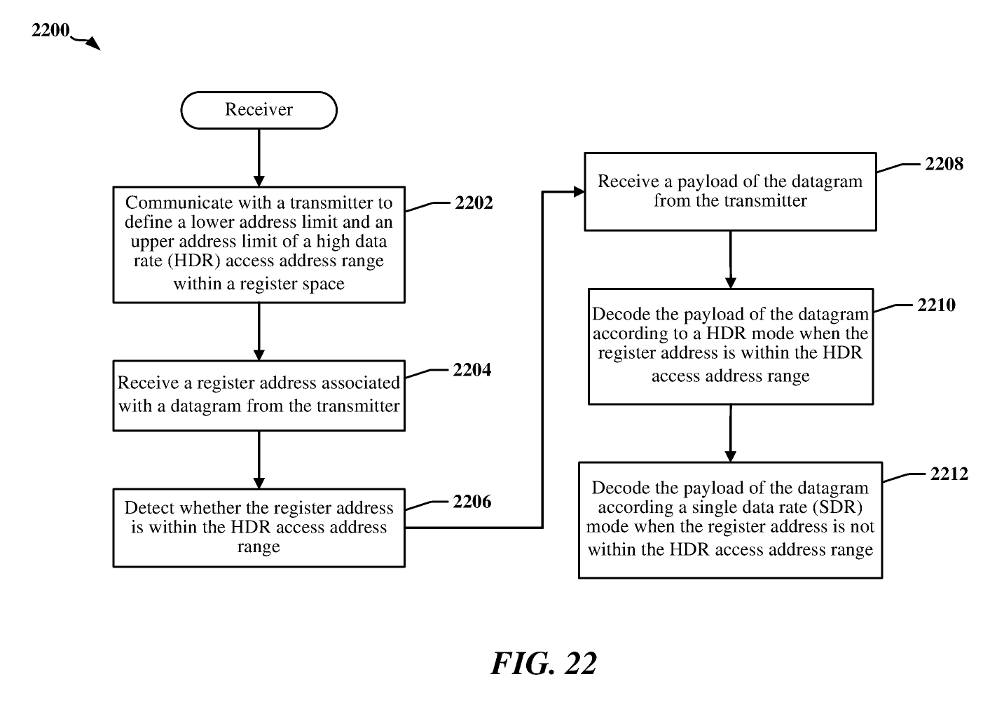

FIG. 22 is a flow chart 2200 of a method for receiving data from a transmitter across a serial bus interface. The method may be performed at a device operating as a receiver (e.g., bus slave).

The device may communicate with the transmitter to define a lower address limit and an upper address limit of a high data rate (HDR) access address range within a register space 2202. The lower address limit may include a most significant byte (MSB) and a least significant byte (LSB). Moreover, the MSB of the lower address limit may be stored in a first lower address register of the register space and the LSB of the lower address limit may be stored in a second lower address register of the register space. The upper address limit may also include a MSB and a LSB. As such, the MSB of the upper address limit may be stored in a first upper address register of the register space and the LSB of the upper address limit may be stored in a second upper address register of the register space.

After the lower and upper limits of the HDR access address range are defined, the device may receive a register address associated with a datagram from the transmitter 2204. The register address may be received according to a single data rate (SDR) mode. The device may detect whether the register address is within the HDR access address range 2206. The device may also receive a payload of the datagram from the transmitter 2208. If the register address is within the HDR access address range, then the device may decode the payload of the datagram according to a HDR mode 2210. The HDR mode may include the DDR mode or other higher order modulation schemes. However, if the register address is not within the HDR access address range, then the device may decode the payload of the datagram according to the SDR mode 2212.

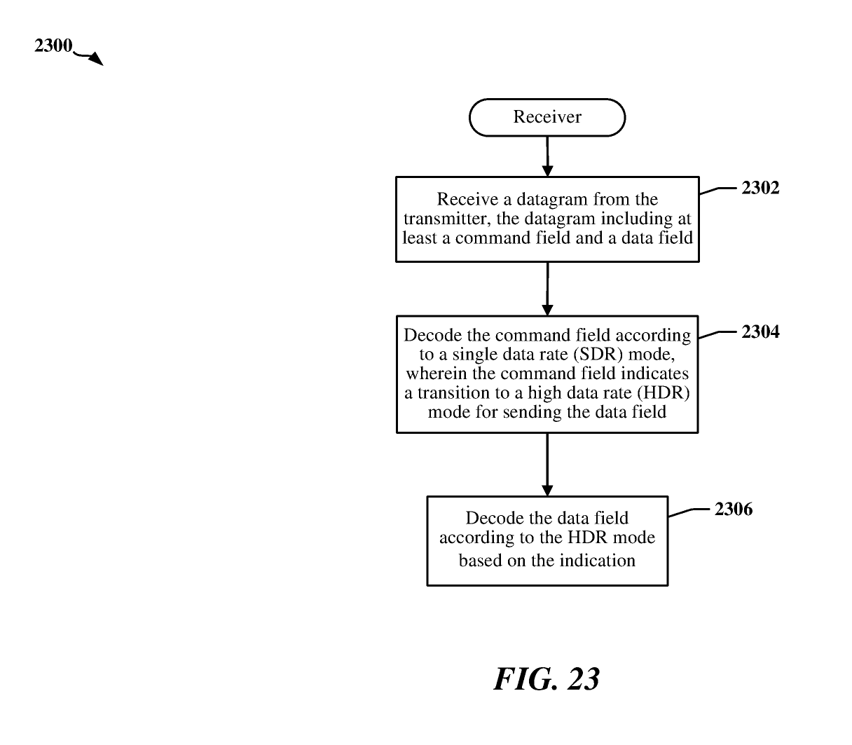

FIG. 23 is a flow chart 2300 of another method for receiving data from a transmitter across a serial bus interface. The method may be performed at a device operating as a receiver (e.g., bus slave).

The device may receive a datagram from the transmitter 2302, wherein the datagram may include at least a command field and a data field. In an aspect of the disclosure, the command field indicates whether the datagram is related to a read operation or a write operation, and indicates whether the datagram is an extended register command, an extended register long command, or a register command. In another aspect of the disclosure, the datagram includes a read/write indication bit indicating whether the datagram is related to a read operation or a write operation, and the command field indicates whether the datagram is an extended register command, an extended register long command, or a register command. In a further aspect of the disclosure, the datagram includes a read/write indication bit indicating whether the datagram is related to a read operation or a write operation, and includes a mode field indicating whether the datagram is an extended register command, an extended register long command, or a register command.

The device may decode the command field according to a single data rate (SDR) mode 2304, wherein the command field indicates a transition to a high data rate (HDR) mode for sending the data field. The device may also decode the data field according to the HDR mode based on the command field indication 2306. The HDR mode may include the DDR mode or other higher order modulation schemes.

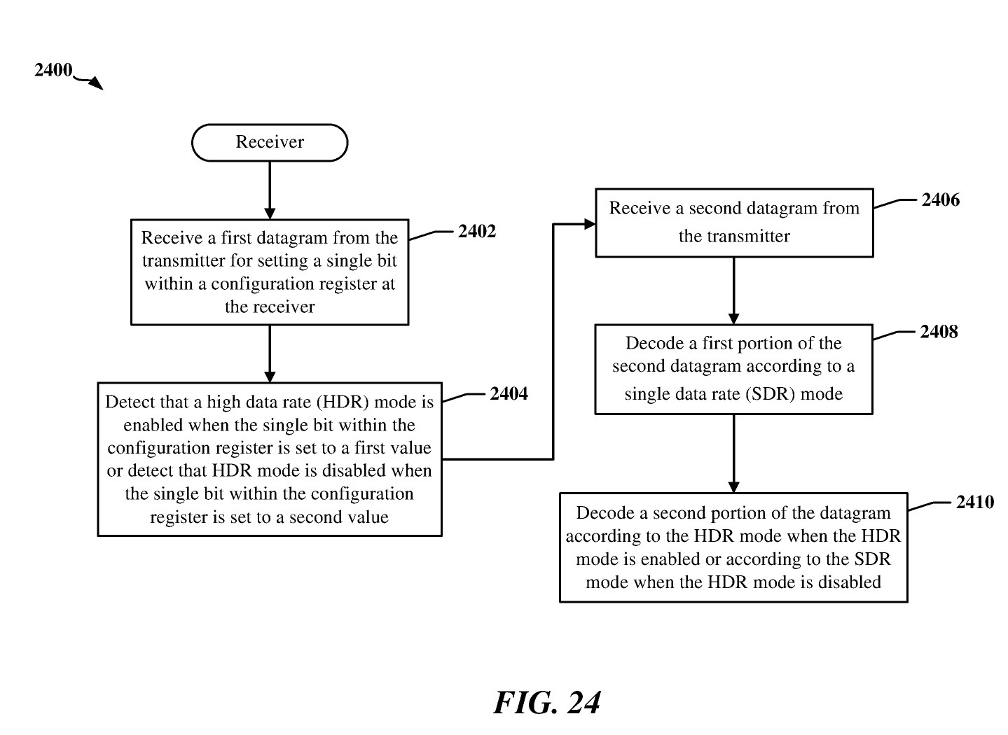

FIG. 24 is a flow chart 2400 of a further method for receiving data from a transmitter across a serial bus interface. The method may be performed at a device operating as a receiver (e.g., bus slave).

The device may receive a first datagram from the transmitter for setting a single bit within a configuration register at the receiver 2402. The device may detect that a high data rate (HDR) mode is enabled when the single bit within the configuration register is set to a first value. Alternatively, the device may detect that the HDR mode is disabled when the single bit within the configuration register is set to a second value 2404. The HDR mode may include the DDR mode or other higher order modulation schemes. In one example, the device may detect that the HDR mode is enabled when a bit D1 in the receiver's configuration register (e.g., register at location 0x18) has a value of “1” as set by the transmitter via a write operation. In another example, the device may detect that the HDR mode is disabled when the bit D1 in the receiver's configuration register (e.g., register at location 0x18) has a value of “0” as set by the transmitter via a write operation.

The device may receive a second datagram from the transmitter 2406. The device may decode a first portion of the second datagram according to a single data rate (SDR) mode 2408.

The device may decode a second portion of the second datagram according to the HDR mode when the HDR mode is enabled or according to the SDR mode when the HDR mode is disabled 2410. The first portion of the second datagram may include a receiver address field and a command field. The second portion of the second datagram may include a register address and a payload.

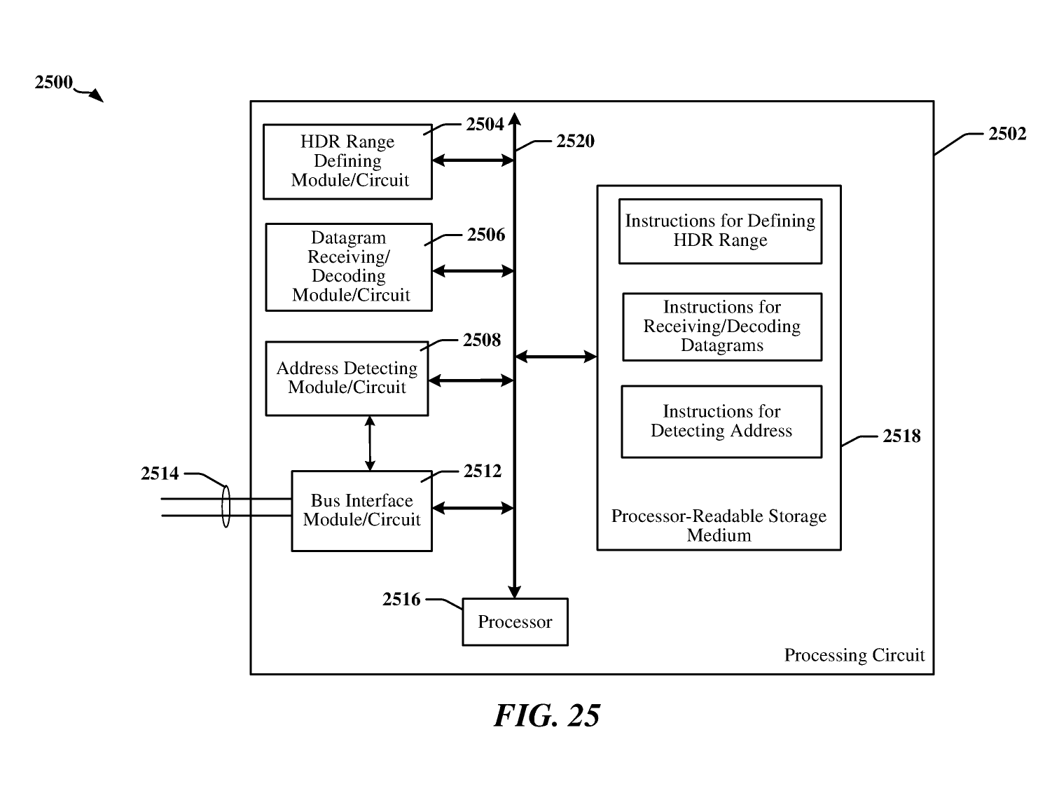

FIG. 25 is a diagram illustrating a simplified example of a hardware implementation for a receiving apparatus 2500 employing a processing circuit 2502. Examples of operations performed by the receiving apparatus 2500 include the operations described above with respect to the flow charts of FIGS. 22, 23, and 24. The processing circuit typically has a processor 2516 that may include one or more of a microprocessor, microcontroller, digital signal processor, a sequencer and a state machine. The processing circuit 2502 may be implemented with a bus architecture, represented generally by the bus 2520. The bus 2520 may include any number of interconnecting buses and bridges depending on the specific application of the processing circuit 2502 and the overall design constraints. The bus 2520 links together various circuits including one or more processors and/or hardware modules, represented by the processor 2516, the modules or circuits 2504, 2506, 2508, bus interface circuits 2512 configurable to support communication over connectors or wires 2514 and the computer-readable storage medium 2518. The bus 2520 may also link various other circuits such as timing sources, peripherals, voltage regulators, and power management circuits, which are well known in the art, and therefore, will not be described any further.

The processor 2516 is responsible for general processing, including the execution of software/instructions stored on the computer-readable storage medium 2518. The software/instructions, when executed by the processor 2516, causes the processing circuit 2502 to perform the various functions described supra for any particular apparatus. The computer-readable storage medium may also be used for storing data that is manipulated by the processor 2516 when executing software, including data decoded from symbols transmitted over the connectors or wires 2514, which may be configured as data lanes and clock lanes. The processing circuit 2502 further includes at least one of the modules/circuits 2504, 2506, and 2508. The modules/circuits 2504, 2506, and 2508 may be software modules running in the processor 2516, resident/stored in the computer-readable storage medium 2518, one or more hardware modules coupled to the processor 2516, or some combination thereof. The modules/circuits 2504, 2506, and/or 2508 may include microcontroller instructions, state machine configuration parameters, or some combination thereof.

In one configuration, the apparatus 2500 for communication includes a HDR range defining module/circuit 2504 that is configured to, communicate with a transmitter to define a lower address limit and an upper address limit of a high data rate (HDR) access address range within a register space. The apparatus 2500 further includes a datagram receiving/decoding module circuit 2506 that is configured to, via the bus interface module/circuit 2512, receive a register address associated with a datagram from the transmitter, receive a payload of the datagram from the transmitter, decode the payload of the datagram according to a HDR mode when the register address is within the HDR access address range and decode the payload of the datagram according to a single data rate (SDR) mode when the register address is not within the HDR access address range. The apparatus 2500 further includes an address detecting module/circuit 2508 that is configured to, detect whether the register address is within the HDR access address range.

In another configuration, the datagram receiving/decoding module circuit 2506 is configured to, receive a datagram from the transmitter, wherein the datagram includes at least a command field and a data field, decode the command field according to a single data rate (SDR) mode, wherein the command field indicates a transition to a high data rate (HDR) mode for sending the data field, and decode the data field according to the HDR mode based on the command field indication.

In a further configuration, the datagram receiving/decoding module circuit 2506 is configured to, receive a first datagram from the transmitter for setting a single bit within a configuration register at the receiver, detect that a high data rate (HDR) mode is enabled when the single bit within the configuration register is set to a first value, detect that the HDR mode is disabled when the single bit within the configuration register is set to a second value, receive a second datagram from the transmitter, decode a first portion of the second datagram according to a single data rate (SDR) mode, decode a second portion of the second datagram according to the HDR mode when the HDR mode is enabled, and decode the second portion of the second datagram according to the SDR mode when the HDR mode is disabled.

It is understood that the specific order or hierarchy of steps in the processes disclosed is an illustration of exemplary approaches. The specific order or hierarchy of steps in the processes may be rearranged based upon design preferences. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.” #

1. A method performed at a transmitter for sending data to a receiver across a serial bus interface, comprising:
generating a datagram based on a register address;
detecting whether the register address is within a high data rate (HDR) access address range; and
sending a payload of the datagram to the receiver according to a HDR mode when the register address is within the HDR access address range.

2. The method of claim 1, further comprising:
sending the register address to the receiver according to a single data rate (SDR) mode.

3. The method of claim 1, further comprising:
sending the payload of the datagram to the receiver according to a single data rate (SDR) mode when the register address is not within the HDR access address range.

4. The method of claim 1, further comprising:
communicating with the receiver to define a lower address limit and an upper address limit of the HDR access address range within a register space.

5. The method of claim 4, wherein the lower address limit includes a most significant byte (MSB) and a least significant byte (LSB), and wherein the MSB is stored in a first lower address register of the register space and the LSB is stored in a second lower address register of the register space.

6. The method of claim 4, wherein the upper address limit includes a most significant byte (MSB) and a least significant byte (LSB), and wherein the MSB is stored in a first upper address register of the register space and the LSB is stored in a second upper address register of the register space.

7. A transmitter for sending data to a receiver, comprising:
a serial bus interface; and
a processing circuit configured to:
generate a datagram based on a register address,
detect whether the register address is within a high data rate (HDR) access address range, and
send a payload of the datagram to the receiver via the serial bus interface according to a HDR mode when the register address is within the HDR access address range.

8. The transmitter of claim 7, the processing circuit further configured to:
send the register address to the receiver according to a single data rate (SDR) mode.

9. The transmitter of claim 7, the processing circuit further configured to:
send the payload of the datagram to the receiver according to a single data rate (SDR) mode when the register address is not within the HDR access address range.

10. The transmitter of claim 7, the processing circuit further configured to:
communicate with the receiver to define a lower address limit and an upper address limit of the HDR access address range within a register space.

11. The transmitter of claim 10, wherein the lower address limit includes a most significant byte (MSB) and a least significant byte (LSB), and wherein the MSB is stored in a first lower address register of the register space and the LSB is stored in a second lower address register of the register space.

12. The transmitter of claim 10, wherein the upper address limit includes a most significant byte (MSB) and a least significant byte (LSB), and wherein the MSB is stored in a first upper address register of the register space and the LSB is stored in a second upper address register of the register space.

13. A method performed at a receiver for receiving data from a transmitter across a serial bus interface, comprising:
receiving, from the transmitter, a register address associated with a datagram;
detecting whether the register address is within a high data rate (HDR) access address range;
receiving a payload of the datagram from the transmitter; and
decoding the payload of the datagram according to a HDR mode when the register address is within the HDR access address range.

14. The method of claim 13, wherein the register address is received according to a single data rate (SDR) mode.

15. The method of claim 13, further comprising:
decoding the payload of the datagram according to a single data rate (SDR) mode when the register address is not within the HDR access address range.

16. The method of claim 13, further comprising:
communicating with the transmitter to define a lower address limit and an upper address limit of the HDR access address range within a register space.

17. The method of claim 16, wherein the lower address limit includes a most significant byte (MSB) and a least significant byte (LSB), and wherein the MSB is stored in a first lower address register of the register space and the LSB is stored in a second lower address register of the register space.

18. The method of claim 16, wherein the upper address limit includes a most significant byte (MSB) and a least significant byte (LSB), and wherein the MSB is stored in a first upper address register of the register space and the LSB is stored in a second upper address register of the register space.

19. A receiver for receiving data from a transmitter, comprising:
a serial bus interface; and
a processing circuit configured to:
receive, from the transmitter via the serial bus interface, a register address associated with a datagram,
detect whether the register address is within a high data rate (HDR) access address range,
receive, from the transmitter via the serial bus interface, a payload of the datagram, and
decode the payload of the datagram according to a HDR mode when the register address is within the HDR access address range.

20. The receiver of claim 19, wherein the register address is received according to a single data rate (SDR) mode.

21. The receiver of claim 19, the processing circuit further configured to:
decode the payload of the datagram according to a single data rate (SDR) mode when the register address is not within the HDR access address range.

22. The receiver of claim 19, the processing circuit further configured to:
communicate with the transmitter to define a lower address limit and an upper address limit of the HDR access address range within a register space.

23. The receiver of claim 22, wherein the lower address limit includes a most significant byte (MSB) and a least significant byte (LSB), and wherein the MSB is stored in a first lower address register of the register space and the LSB is stored in a second lower address register of the register space.

24. The receiver of claim 22, wherein the upper address limit includes a most significant byte (MSB) and a least significant byte (LSB), and wherein the MSB is stored in a first upper address register of the register space and the LSB is stored in a second upper address register of the register space.

25. A method performed at a transmitter for sending data to a receiver across a serial bus interface, comprising:
generating a datagram, the datagram including at least a command field and a data field;
sending the command field to the receiver according to a single data rate (SDR) mode, wherein the command field indicates a transition to a high data rate (HDR) mode for sending the data field; and
sending the data field to the receiver according to the HDR mode.

26. The method of claim 25, wherein:
the command field indicates whether the datagram is related to a read operation or a write operation; and
the command field indicates whether the datagram is an extended register command, an extended register long command, or a register command.

27. The method of claim 25, wherein:
the datagram includes a read/write indication bit indicating whether the datagram is related to a read operation or a write operation; and
the command field indicates whether the datagram is an extended register command, an extended register long command, or a register command.

28. The method of claim 25, wherein:
the datagram includes a read/write indication bit indicating whether the datagram is related to a read operation or a write operation; and
the datagram includes a mode field indicating whether the datagram is an extended register command, an extended register long command, or a register command.

29. A transmitter for sending data to a receiver, comprising:
a serial bus interface; and
a processing circuit configured to:
generate a datagram, the datagram including at least a command field and a data field,
send the command field to the receiver via the serial bus interface according to a single data rate (SDR) mode, wherein the command field indicates a transition to a high data rate (HDR) mode for sending the data field, and
send the data field to the receiver via the serial bus interface according to the HDR mode.

30. A method performed at a receiver for receiving data from a transmitter across a serial bus interface, comprising:
receiving a datagram from the transmitter, the datagram including at least a command field and a data field;
decoding the command field according to a single data rate (SDR) mode, wherein the command field indicates a transition to a high data rate (HDR) mode for sending the data field; and
decoding the data field according to the HDR mode based on the command field indication.

31. The method of claim 30, wherein:
the command field indicates whether the datagram is related to a read operation or a write operation; and
the command field indicates whether the datagram is an extended register command, an extended register long command, or a register command.

32. The method of claim 30, wherein:
the datagram includes a read/write indication bit indicating whether the datagram is related to a read operation or a write operation; and
the command field indicates whether the datagram is an extended register command, an extended register long command, or a register command.

33. The method of claim 30, wherein:
the datagram includes a read/write indication bit indicating whether the datagram is related to a read operation or a write operation; and
the datagram includes a mode field indicating whether the datagram is an extended register command, an extended register long command, or a register command.

34. A receiver for receiving data from a transmitter, comprising:
a serial bus interface; and
a processing circuit configured to:
receive a datagram from the transmitter via the serial bus interface, the datagram including at least a command field and a data field,
decode the command field according to a single data rate (SDR) mode, wherein the command field indicates a transition to a high data rate (HDR) mode for sending the data field, and
decode the data field according to the HDR mode based on the command field indication.

35. A method performed at a transmitter for sending data to a receiver across a serial bus interface, comprising:
enabling a high data rate (HDR) mode by setting a single bit within a configuration register at the receiver to a first value;
generating a datagram to be transmitted to the receiver via the serial bus interface;
sending a first portion of the datagram according to a single data rate (SDR) mode; and
sending a second portion of the datagram according to the HDR mode when the HDR mode is enabled.

36. The method of claim 35, wherein:
the first portion of the datagram includes a receiver address field and a command field; and
the second portion of the datagram includes a register address and a payload.

37. The method of claim 35, further comprising:
disabling the HDR mode by setting the single bit within the configuration register at the receiver to a second value; and
sending the second portion of the datagram according to the SDR mode when the HDR mode is disabled.

38. A transmitter for sending data to a receiver, comprising:
a serial bus interface; and
a processing circuit configured to:
enable a high data rate (HDR) mode by setting a single bit within a configuration register at the receiver to a first value,
generate a datagram to be transmitted to the receiver via the serial bus interface,
send a first portion of the datagram according to a single data rate (SDR) mode, and
send a second portion of the datagram according to the HDR mode when the HDR mode is enabled.

39. The transmitter of claim 38, wherein:
the first portion of the datagram includes a receiver address field and a command field; and
the second portion of the datagram includes a register address and a payload.

40. The transmitter of claim 38, wherein the processing circuit is further configured to:
disable the HDR mode by setting the single bit within the configuration register at the receiver to a second value; and
send the second portion of the datagram according to the SDR mode when the HDR mode is disabled.

41. A method performed at a receiver for receiving data from a transmitter across a serial bus interface, comprising:
receiving a first datagram from the transmitter for setting a single bit within a configuration register at the receiver;
detecting that a high data rate (HDR) mode is enabled when the single bit within the configuration register is set to a first value;
receiving a second datagram from the transmitter;
decoding a first portion of the second datagram according to a single data rate (SDR) mode; and
decoding a second portion of the second datagram according to the HDR mode when the HDR mode is enabled.

42. The method of claim 41, wherein:
the first portion of the second datagram includes a receiver address field and a command field; and
the second portion of the second datagram includes a register address and a payload.

43. The method of claim 41, further comprising:
detecting that the HDR mode is disabled when the single bit within the configuration register is set to a second value; and
decoding the second portion of the second datagram according to the SDR mode when the HDR mode is disabled.

44. A receiver for receiving data from a transmitter, comprising:
a serial bus interface; and
a processing circuit configured to:
receive, via the serial bus interface, a first datagram from the transmitter for setting a single bit within a configuration register at the receiver,
detect that a high data rate (HDR) mode is enabled when the single bit within the configuration register is set to a first value,
receive, via the serial bus interface, a second datagram from the transmitter,
decode a first portion of the second datagram according to a single data rate (SDR) mode, and
decode a second portion of the second datagram according to the HDR mode when the HDR mode is enabled.

45. The receiver of claim 44, wherein:
the first portion of the second datagram includes a receiver address field and a command field; and
the second portion of the second datagram includes a register address and a payload.

46. The receiver of claim 44, wherein the processing circuit is further configured to:
detect that the HDR mode is disabled when the single bit within the configuration register is set to a second value; and
decode the second portion of the second datagram according to the SDR mode when the HDR mode is disabled.
